(19) United States
(12) Patent Application Publication
(10) Pub. No.: US 2009/0232024 A1
(43) Pub. Date: Sep. 17, 2009

(54) NODE DISCOVERY METHOD FOR PROVIDING OPTIMAL PATH PRESERVING LOCATION PRIVACY

(75) Inventors: Takako Hori, Kanagawa (JP); Toyoki Ue, Kanagawa (JP); Hong Cheng, Singapores (SG)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/306,080

(22) PCT Filed: Jun. 29, 2007
(86) PCT No.: PCT/JP2007/063520

§ 371 Date: Dec. 22, 2008

(30) Foreign Application Priority Data
Jun. 30, 2006 (JP) 2006-181983
Nov. 6, 2006 (JP) 2006-300851

(51) Int. Cl. H04L 12/28; H04L 12/56; H04B 7/14

(52) U.S. Cl. 370/254; 370/400; 370/315

(57) ABSTRACT

A technology that can provide a node discovery method that can detect a TA that can provide a quasi-optimal data path to acquire the quasi-optimal path while protecting location privacy of a MN and the like are disclosed. The technology includes a step in which a first proxy node 105 that is a proxy node that discovers a processing node 102 as a proxy of a mobile node 101 transmits a first message in a predetermined format used to discover the processing node to a second proxy node 106 that is a proxy node that discovers the processing node as a proxy of a corresponding node. The technology also includes a step in which a relay node that has received the first message and can process the message in the predetermined format judges whether the relay node itself is the processing node based on the first message. The technology also includes a step in which, when judged that the relay node itself is the processing node, the relay node that has made the judgment and can process the message in the predetermined format transmits a second message to the first proxy node stating that the relay node itself will become the processing node.

### TECHNICAL FIELD

The present invention relates to a node discovery method for discovering a node providing a path closest to an optimal path while preserving location privacy, a proxy node used in the method, a mobile node used in the method, a corresponding node used in the method, and a home agent used in the method.

### BACKGROUND ART

A technology using a mobile Internet Protocol version 6 (mobile IPv6) is becoming popular as a technology that can provide a user accessing a communication network, such as the Internet, from a mobile node through a wireless network with a seamless connection to the communication network, even during movement. The mobile IPv6 is a next-generation internet protocol. Two communicating nodes are both mobile nodes (MN) supporting the mobile IPv6. An operation performed when the two mobile nodes (MN 1 and MN 2) are in an external network will be described with reference to FIG. 17. When the MN 1 and the MN 2 do not know the care of address (CoA) used by each other in the external network, a packet is transmitted and received through a path 1, via a home agent (HA) 1 and a HA 2, shown in FIG. 17, as described in Non-patent Document 1, below. When the MN 1 and the MN 2 know each other's CoA, the packet transmitted from the MN 1 to the MN 2 is transmitted by an optimal path, such as a path 2 shown in FIG. 17.

However, when the optimal path is being used, the MN 1 is required to inform the MN 2 of the CoA that the MN 1 itself is currently using. Additionally, the MN 2 is required to inform the MN 1 of the CoA that the MN 2 itself is currently using. As a result, the MN informs the other MN of its own current location. In other words, location privacy cannot be preserved. Therefore, the Internet Engineering Task Force (IETF) is currently discussing methods of securing a path closest to the optimal path (referred to, hereafter, as a quasi-optimal path) while preserving location privacy. Route optimization and location privacy using tunneling agent (ROTA) described in Non-patent Document 2, below, is given as a method thereof. In ROTA, a node referred to as a tunneling agent (TA) is used. The quasi-optimal path is secured by an endpoint of tunneling between a MN and a HA being moved to the TA. According to the description in Non-patent Document 2, there are two methods for selecting the TA. In one method, either of the HA of the MN 1 and the HA of the MN 2 is selected as the TA, as shown in FIG. 18A. In the other method, when a local HA or mobility anchor point (MAP) is present, the local HA or MAP is selected as the TA, as shown in FIG. 18B.

### Non-patent Document 1: D. Johnson, C. Perkins and J. Arkko, “Mobility Support in IPv6”, RFC3775, June 2004

Non-patent Document 2: K. Weniger and T. Aramaki, “Route Optimization and Location Privacy using Tunneling Agent (ROTA)”, draft-weniger-rota-01, October 2005
Non-patent Document 3: R. Hancock (editor), G. Karagiannis, J. Loughney and S. Van den Bosch, “Next Steps in Signaling (NSIS): Framework”, RFC4080, June 2005

### Non-patent Document 4: M. Liebsch, A. Singh, H. Chaskar, D. Funato and E. Shim, “Candidate Access Router Discovery (CARD)”, RFC4066, July 2005

### Non-patent Document 5: D. Johnson, S. Deering “Reserved IPv6 Subnet Anycast Address”, RFC2526

### Non-patent Document 6: H. Soliman, C. Castelluccia, K. ElMalki, L. Bellier “Hierarchical Mobile IPv6 Mobility Management (HMIPv6)”, RFC4140

However, in the method of selecting the HA as the TA in the ROTA procedure (FIG. 18A), when the HA to serve as the TA is far away from the MN 1 and the MN 2, the path obtained is not very quasi-optimal. Moreover, in the method of selecting the local HA or MAP as the TA (FIG. 18B), a local HA or MAP is not always found at a destination of the MN. Even when the local HA or MAP is found, TA functionality may not necessarily be supported.

### DISCLOSURE OF THE INVENTION

In light of the above-described problems, an object of the present invention is to provide a node discovery method, a proxy node used in the method, a mobile node used in the method, a corresponding node used in the method, and a home agent used in the method. In the node discovery method, a TA can be detected that can provide a quasi-optimal data path to acquire the quasi-optimal data path while preserving location privacy of a MN, in the mobile IPv6. Moreover, a TA that can provide an even more optimal data path can be detected.

To achieve the above-described object, a node discovery method of the present invention is a node discovery method in which, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, a processing node is discovered from among the plurality of relay nodes. The processing node is a relay node that can process a message in a predetermined format and is positioned on a path over which a data packet transmitted from the mobile node to the corresponding node passes. The node discovery method includes a step in which a first proxy node that is a proxy node that discovers the processing node as a proxy of the mobile node transmits a first message to a second proxy node that is a proxy node that discovers the processing node as a proxy of the corresponding node. The first message is the message in the predetermined format used to discover the processing node. The node discovery method also includes a step in which a rely node that has received the first message and can process the message in the predetermined format judges whether the relay node itself is the processing node, based on the first message. The node discovery method also includes a step in which, when judged at the judging step that the relay node itself is the processing node, the relay node that has made the judgment and can process the message in the predetermined format transmits a second message stating that the relay node itself will become the processing node to the first proxy node. As a result of the configuration, a TA that can provide a quasi-optimal data path can be detected to acquire the quasi-optimal path while protecting location privacy of the mobile node (MN). The TA is equivalent to the above-described processing node.

In addition, in the node discovery method of the present invention, a preferred aspect of the present invention is that the first message includes predetermined hop information for making the relay node that can process the message in the predetermined format, positioned a predetermined hop ahead of the first proxy node on a path over which the first message is transmitted, the processing node. As a result, the processing node can be easily decided.

A node discovery method of the present invention is a node discovery method in which, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, a processing node is discovered from among the plurality of relay nodes. The processing node is a relay node that can process a message in a predetermined format and is positioned on a path over which a data packet transmitted from the mobile node to the corresponding node passes. The node discovery method includes a step in which a first proxy node that is a proxy node that discovers the processing node as a proxy of the mobile node transmits a first message to a second proxy node that is a proxy node that discovers the processing node as a proxy of the corresponding node. The first message is the message in the predetermined format used to discover the processing node. The node discovery method also includes a step in which a rely node that has received the first message and can process the message in the predetermined format adds address information of the relay node itself to the first message and transfers the first message. The node discovery method also includes a step in which the second proxy node decides the processing node based on the first message to which the address information has been added. As a result of the configuration, a TA that can provide a quasi-optimal data path can be detected to acquire the quasi-optimal path while protecting location privacy of the mobile node (MN).

In addition, in the node discovery method of the present invention, a preferred aspect of the present invention is that the second proxy node decides the processing node to be the relay node that can process the message in the predetermined format, positioned halfway between the first proxy node and the second proxy node, based on a number of pieces of address information added to the first message. As a result of the configuration, location privacy can be protected with further certainty.

In addition, in the node discovery method of the present invention, a preferred aspect of the present invention is that the first message includes information prompting the relay node that can process the message in the predetermined format to acquire the first message. As a result of the configuration, the relay node that can process the message in the predetermined format can intercept the first message.

In addition, in the node discovery method of the present invention, a preferred aspect of the present invention is that the mobile node transmits a third message that is a message in the predetermined format to a predetermined node that can process the message in the predetermined format, to extract the first proxy node from among the relay nodes. The relay node that can process the message with the predetermined format and has received the third message judges whether the relay node itself is the first proxy node, based on the third message. When judged that the relay node itself is the first proxy node, the relay node transmits a fourth message stating that the relay node itself is the first proxy node to the mobile node. As a result, the first proxy node is decided. As a result of the configuration, the first proxy node can be easily extracted.

In addition, in the node discovery method of the present invention, a preferred aspect of the present invention is that the third message includes information prompting the relay node that can process the message in the predetermined format to acquire the third message. As a result of the configuration, the message can be intercepted.

In addition, in the node discovery method of the present invention, a preferred aspect of the present invention is that the third message includes predetermined hop information for making the relay node that can process the message in the predetermined format, positioned a predetermined hop ahead of the mobile node on a path over which the third message is transmitted, the first proxy node. As a result, the first proxy node can be easily decided.

In addition, in the node discovery method of the present invention, a preferred aspect of the present invention is that the mobile node transmits a fifth message for acquiring address information of the second proxy node to the first proxy node. As a result of the configuration, the address information of the second proxy node can be acquired.

In addition, in the node discovery method of the present invention, a preferred aspect of the present invention is that the mobile node transmits a message requesting designation of the first proxy node to the home agent of the mobile node. The home agent of the mobile node decides the first proxy node based on address information of the mobile node and transmits information on the decided first proxy node to the mobile node. As a result of the configuration, the mobile node can easily acquire the information on the first proxy node.

In addition, in the node discovery method of the present invention, a preferred aspect of the present invention is that, when the mobile node moves from the first network and connects to another network within the internetwork, a first path and a second path intersect. The message in the predetermined format transmitted to discover a pre-movement processing node that is the processing node when the mobile node is connected to the first network before movement passes over the first path. The message in the predetermined format transmitted to discover the processing node in the other network of a new connection destination passes over the second path. If a relay node that can process the message in the predetermined format and is immediately after a convergence of the first path and the second path is positioned closer to the mobile node side than the pre-movement processing node on the converged path, the pre-movement processing node is continuously used as the processing node. As a result of the configuration, location privacy of the mobile node (MN) is continuously protected.

A proxy node of the present invention is a proxy node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method. In the node discovery method, a processing node is discovered from among the plurality of relay nodes. The processing node is a relay node that can process a message in a predetermined format and is positioned on a path over which a data packet transmitted from the mobile node to the corresponding node passes. The proxy node discovers the processing node as a proxy of the mobile node. The proxy node includes a message generating means that generates a first message that is the message in the predetermined format used to discover the processing node. The proxy node also includes a transmitting means that transmits the generated first message to a second proxy node that is a proxy node that discovers the processing node as a proxy of the corresponding node. The proxy node also includes a receiving means that, when a rely node that has received the transmitted first message and can process the message in the predetermined format judges that the relay node itself will become the processing node based on the first message, receives a second message from the relay node that has made the judgment stating that the relay node will become the processing node. As a result of the configuration, a TA that can provide a quasi-optimal data path can be detected to acquire the quasi-optimal path while protecting location privacy of the mobile node (MN).

In addition, in the proxy node of the present invention, a preferred aspect of the present invention is that the first message includes predetermined hop information for making the relay node that can process the message in the predetermined format, positioned a predetermined hop ahead of the proxy node itself on a path over which the first message is transmitted, the processing node. As a result, the processing node can be easily decided.

A proxy node of the present invention is a proxy node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method. In the node discovery method, a processing node is discovered from among the plurality of relay nodes. The processing node is a relay node that can process a message in a predetermined format and is positioned on a path over which a data packet transmitted from the mobile node to the corresponding node passes. The proxy node discovers the processing node as a proxy of the mobile node. The proxy node includes a message generating means that generates a first message that is the message in the predetermined format used to discover the processing node. The proxy node also includes a transmitting means that transmits the generated first message to a second proxy node that is a proxy node that discovers the processing node as a proxy of the corresponding node. The proxy node also includes a receiving means that receives a message from the processing node discovered by the second proxy node stating that the processing node itself will become the processing node. As a result of the configuration, a TA that can provide a quasi-optimal data path can be detected to acquire the quasi-optimal path while protecting location privacy of the mobile node (MN).

In addition, in the proxy node of the present invention, a preferred aspect of the present invention is that the first message includes information prompting the relay node that can process the message in the predetermined format to acquire the first message. As a result of the configuration, the relay node that can process the message in the predetermined format can intercept the first message.

In addition, in the proxy node of the present invention, a preferred aspect of the present invention is that the proxy node further includes a judging means that judges whether the proxy node itself is a first proxy node that is proxy node of the mobile node, based on a third message that is the message in the predetermined format transmitted from the mobile node and received by the receiving means to extract the first proxy node from the relay nodes. When the judging means judges that the proxy node itself is the first proxy node, the message generating means generates a fourth message stating that the proxy node itself is the first proxy node. The transmitting means transmits the generated fourth message to the mobile node. As a result of the configuration, the first proxy node can be easily extracted.

In addition, in the proxy node of the present invention, a preferred aspect of the present invention is that the third message includes information prompting the relay node that can process the message in the predetermined format to acquire the third message. As a result of the configuration, the relay node that can process the message in the predetermined format can intercept the third message.

In addition, in the proxy node of the present invention, a preferred aspect of the present invention is that the third message includes predetermined hop information for making the relay node that can process the message in the predetermined format, positioned a predetermined hop ahead of the mobile node on a path over which the third message is transmitted, the first proxy node. As a result, the first proxy node can be easily decided.

In addition, in the proxy node of the present invention, a preferred aspect of the present invention is that the receiving means receives a fifth message from the mobile node for acquiring address information of the second proxy node. As a result of the configuration, a process for acquiring the address information of the second proxy node can be started.

A proxy node of the present invention is a proxy node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method. In the node discovery method, a processing node is discovered from among the plurality of relay nodes. The processing node is a relay node that can process a message in a predetermined format and is positioned on a path over which a data packet transmitted from the mobile node to the corresponding node passes. The proxy node discovers the processing node as a proxy of the corresponding node. The proxy node includes a receiving means that receives a first message that is the message in the predetermined format used to discover the processing node transmitted by a first proxy node that is a proxy node that discovers the processing node as a proxy of the mobile node, to which a relay node that has received the first message and can process the message in the predetermined format has added address information of the relay node itself. The proxy node also includes a deciding means that decides the processing node based on the received first message to which the address information has been added. As a result of the configuration, a TA that can provide a quasi-optimal data path can be detected to acquire the quasi-optimal path while protecting location privacy of the mobile node (MN).

In addition, in the proxy node of the present invention, a preferred aspect of the present invention is that the deciding means decides the processing node to be a relay node that can process the message in the predetermined format, positioned halfway between the first proxy node and the proxy node itself, based on a number of pieces of the address information added to the first message. As a result of the configuration, location privacy can be protected with further certainty.

In addition, in the proxy node of the present invention, a preferred aspect of the present invention is that the first message includes information prompting the relay node that can process the message in the predetermined format to acquire the first message. As a result of the configuration, the relay node that can process the message in the predetermined format can intercept the first message.

A mobile node of the present invention is a mobile node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method. In the node discovery method, a processing node is discovered from among the plurality of relay nodes. The processing node is a relay node that can process a message in a predetermined format and is positioned on a path over which a data packet transmitted from the mobile node to the corresponding node passes. The mobile node includes a message generating means that generates a first message that is the message in the predetermined format for extracting a first proxy node. The first proxy node is a proxy node that discovers the processing node, from among the relay nodes, as a proxy of the mobile node. The mobile node also includes a transmitting means that transmits the generated first message to a predetermined node that can process the message. The mobile node also includes a receiving means that receives a second message sent when a rely node that has received the transmitted first message and can process the message in the predetermined format judges that the relay node itself is the first proxy node. The second message states that the relay node itself is the first proxy node. As a result of the configuration, a TA that can provide a quasi-optimal data path can be detected to acquire the quasi-optimal path while protecting location privacy of the mobile node (MN).

In addition, in the mobile node of the present invention, a preferred aspect of the present invention is that the first message includes information prompting the relay node that can process the message in the predetermined format to acquire the first message. As a result of the configuration, the relay node that can process the message in the predetermined format can intercept the first message.

In addition, in the mobile node of the present invention, a preferred aspect of the present invention is that the first message includes predetermined hop information for making the relay node that can process the message in the predetermined format, positioned a predetermined hop ahead of the mobile node on a path over which the first message is transmitted, the first proxy node. As a result, the first proxy node can be easily decided.

In addition, in the mobile node of the present invention, a preferred aspect of the present invention is that the transmitting means transmits a third message to the first proxy node for acquiring address information of a second proxy node that is a proxy node of the corresponding node. As a result of the configuration, the first proxy node can start a process of acquiring the address information of the second proxy node.

A mobile node of the present invention is a mobile node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method. In the node discovery method, a processing node is discovered from among the plurality of relay nodes. The processing node is a relay node that can process a message in a predetermined format and is positioned on a path over which a data packet transmitted from the mobile node to the corresponding node passes. The mobile node includes a message generating means that generates a message requesting designation of a first proxy node. The first proxy node is a proxy node that discovers the processing node, from among the relay nodes, as a proxy of the mobile node. The mobile node also includes a transmitting means that transmits the generated message to the home agent of the mobile node. The mobile node also includes a receiving means that receives information on the first proxy node decided based on address information of the mobile node transmitted by the home agent of the mobile node. As a result of the configuration, a TA that can provide a quasi-optimal data path can be detected to acquire the quasi-optimal path while protecting location privacy of the mobile node (MN).

A node discovery method of the present invention is a node discovery method in which, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, a processing node is discovered from among the plurality of relay nodes. The processing node is a relay node positioned on a direct path between the mobile node and the corresponding node. The node discovery method includes a step in which a first proxy node that is a proxy node that discovers the processing node as a proxy of the mobile node transmits a first message (referred to, hereinafter, as TA-Init-Request) for requesting a discovery of the processing node to the home agent of the corresponding node. The node discovery method also includes a step in which the home agent of the corresponding node transmits a second message (referred to, hereinafter, as TA-Disc-Init) for starting the discovery of the processing node to a second proxy node that is a proxy node that discovers the processing node as a proxy of the corresponding node, based on the first message. The node discovery method also includes a step in which the second proxy node transmits a third message (referred to, hereinafter, as TA-Disc) for discovering the processing node towards the first proxy node, based on the second message. The node discovery method also includes a step in which, when the relay node that has received the third message judges whether the relay node itself can be the processing node based on the third message and judges that the relay node itself can be the processing node, when another relay node that can be the processing node is present between the relay node itself and the first proxy node, the relay node adds address information of the relay node itself to the third message and transfers the message. When another relay node that can be the processing node is not present between the relay node itself and the first proxy node, the relay node transmits a fourth message (referred to, hereinafter, as TA-Response) to the first proxy node. The fourth message includes address information of other relay nodes that can be the processing node included in the third message and address information of the relay node itself. As a result of the configuration, a TA that can provide a more optimal data path can be detected while protecting location privacy of the MN.

In addition, in the node discovery method of the present invention, a preferred aspect of the present invention is that the first proxy node transmits the first message to the home agent of the corresponding node when the mobile node requests the discovery of the processing node. As a result of the configuration, the processing node can be discovered by an instruction from the mobile node.

In addition, in the node discovery method of the present invention, a preferred aspect of the present invention is that, after receiving the fourth message, the first proxy node extracts address information of the relay node that can be the processing node included in the fourth message and transmits a fifth message (referred to, hereinafter, as TA-Disc-Response) including the extracted address information to the mobile node. As a result of the configuration, the mobile node can select a suitable processing node.

In addition, in the node discovery method of the present invention, a preferred aspect of the present invention is that the home agent of the corresponding node decides the second proxy node based on information (referred to, hereinafter, as an entry) for deciding the second proxy node, generated in advance, and information included in the first message and transmits the second message to the decided second proxy node. As a result of the configuration, a suitable processing node can be selected.

In addition, in the node discovery method of the present invention, a preferred aspect of the present invention is that, when the home agent of the corresponding node transmits the second message to a plurality of second proxy nodes, the first proxy node transmits the fifth message to the mobile node based on information included in the third message transmitted from each the second proxy node. The information indicates that the message has been transmitted over a plurality of paths. As a result of the configuration, even when the message is transmitted over a plurality of paths, a single, collective message can be transmitted to the mobile node. Processing load can be reduced.

In addition, in the node discovery method of the present invention, a preferred aspect of the present invention is that, when the corresponding node is present within the second home network, the home agent of the corresponding node decides to become the second proxy node. As a result of the configuration, the load of transmitting the message can be reduced and a suitable processing node can be discovered.

In addition, in the node discovery method of the present invention, a preferred aspect of the present invention is that, when a Hierarchical Mobile Internet Protocol (HMIP) that is a local mobility scheme is used in the data communication system, a router that is an entrance and an exit of a hierarchical structure is decided as the second proxy node. As a result of the configuration, the effort of discovering the proxy node is eliminated and a suitable processing node can be discovered.

In addition, in the node discovery method of the present invention, a preferred aspect of the present invention is that, when the first proxy node and the second proxy node belong to a same domain, the home agent of the corresponding node becomes the processing node. As a result of the configuration, the load of transmitting the message can be reduced and a suitable processing node can be discovered.

A node discovery method of the present invention is a node discovery method in which, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, a processing node is discovered from among the plurality of relay nodes. The processing node is a relay node positioned on a direct path between the mobile node and the corresponding node. The node discovery method includes a step in which a first proxy node that is a proxy node that discovers the processing node as a proxy of the corresponding node transmits a first message for requesting a discovery of the processing node to the home agent of the mobile node. The node discovery method also includes a step in which the home agent of the mobile node transmits a second message for starting the discovery of the processing node to a second proxy node that is a proxy node that discovers the processing node as a proxy of the mobile node, based on the first message. The node discovery method also includes a step in which the second proxy node transmits a third message for discovering the processing node towards the first proxy node, based on the second message. The node discovery method also includes a step in which, when the relay node that has received the third message judges whether the relay node itself can be the processing node based on the third message and the relay node judges that the relay node itself can be the processing node, when another relay node that can be the processing node is present between the relay node itself and the first proxy node, the relay node adds address information of the relay node itself to the third message and transfers the message. When another relay node that can be the processing node is not present between the relay node itself and the first proxy node, the relay node transmits a fourth message (referred to, hereinafter, as TA-Response) to the first proxy node. The fourth message includes address information of other relay nodes that can be the processing node included in the third message and address information of the relay node itself. As a result of the configuration, the corresponding node side can also prompt the discovery of the processing node.

A proxy node of the present invention is a proxy node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method. In the node discovery method, a processing node is discovered from among the plurality of relay nodes. The processing node is a relay node positioned on a direct path between the mobile node and the corresponding node. The proxy node discovers the processing node as a proxy of the mobile node. The proxy node includes a message generating means that generates a first message (referred to, hereinafter, as TA-Init-Request) for requesting a discovery of the processing node. The proxy node also includes a transmitting means that transmits the generated first message to the home agent of the corresponding node. As a result of the configuration, a TA that can provide a more optimal data path can be detected while protecting location privacy of the MN.

In addition, in the proxy node of the present invention, a preferred aspect of the present invention is that the proxy node further includes a receiving means that receives a second message (referred to, hereinafter, as TA-Init-Request) from the mobile node for requesting a discovery of the processing node. When the receiving means receives the second message, the proxy node transmits the first message to the home agent of the corresponding node. As a result of the configuration, the processing node can be discovered by an instruction from the mobile node.

In addition, in the proxy node of the present invention, a preferred aspect of the present invention is that the receiving means receives a third message (referred to, hereinafter, as TA-Response) including address information of the relay node that can be the processing node. The message generating means extracts the address information of the relay node that can be the processing node included in the third message and generates a fourth message (referred to, hereinafter, as TA-Disc-Response) including the extracted address information. The transmitting means transmits the generated fourth message to the mobile node. As a result of the configuration, the mobile node can select the suitable processing node.

In addition, in the proxy node of the present invention, a preferred aspect of the present invention is that, when the home agent of the corresponding node transmits a message for starting the discovery of the processing node (referred to, hereinafter, as TA-Disc-Init) to a plurality of communication proxy nodes that discovers the processing node as a proxy of the corresponding node, the transmitting means transmits the fourth message to the mobile node, based on information included in a fifth message (referred to, hereafter, as TA-Disc) for discovering the processing node, transmitted from each the communication proxy node. The information indicates that the message has been transmitted over a plurality of paths. As a result of the configuration, even when the message is transmitted over a plurality of paths, a single, collective message can be transmitted to the mobile node. Processing load can be reduced.

In addition, in the proxy node of the present invention, a preferred aspect of the present invention is that, when the corresponding node is present within the second home network, the home agent of the corresponding node decides to become the communication proxy node. As a result of the configuration, the load of transmitting the message can be reduced and a suitable processing node can be discovered.

In addition, in the proxy node of the present invention, a preferred aspect of the present invention is that, when a HMIP that is a local mobility scheme is used in the data communication system, a router that is an entrance and an exit of a hierarchical structure is decided as the communication proxy node. As a result of the configuration, the effort of discovering the proxy node is eliminated and a suitable processing node can be discovered.

In addition, in the proxy node of the present invention, a preferred aspect of the present invention is that, when the proxy node itself and the communication proxy node belong to a same domain, the home agent of the corresponding node becomes the processing node. As a result of the configuration, the load of transmitting the message can be reduced and a suitable processing node can be discovered.

A proxy node of the present invention is a proxy node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method. In the node discovery method, a processing node is discovered from among the plurality of relay nodes. The processing node is a relay node positioned on a direct path between the mobile node and the corresponding node. The proxy node discovers the processing node as a proxy of the mobile node. The proxy node includes a receiving means that receives a second message (referred to, hereinafter, as TA-Disc-Init) for starting a discovery of the processing node based on a first message (referred to, hereinafter, as TA-Init-Request) for requesting the discovery of the processing node. The proxy node also includes a message generating means that generates a third message (referred to, hereinafter, as TA-Disc) for discovering the processing node based on the received second message. The proxy node also includes a transmitting means that transmits the generated third message to a first proxy node that is proxy node of the corresponding node. As a result of the configuration, the corresponding node side can also prompt the discovery of the processing node.

A proxy node of the present invention is a proxy node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method. In the node discovery method, a processing node is discovered from among the plurality of relay nodes. The processing node is a relay node positioned on a direct path between the mobile node and the corresponding node. The proxy node discovers the processing node as a proxy of the corresponding node.

The proxy node includes a receiving means that receives a second message (referred to, hereinafter, as TA-Disc-Init) for starting a discovery of the processing node based on a first message (referred to, hereinafter, as TA-Init-Request) for requesting the discovery of the processing node. The proxy node also includes a message generating means that generates a third message (referred to, hereinafter, as TA-Disc) for discovering the processing node based on the received second message. The proxy node also includes a transmitting means that transmits the generated third message to a first proxy node that is proxy node of the mobile node. As a result of the configuration, a TA that can provide a more optimal data path can be detected while protecting location privacy of the MN.

In addition, in the proxy node of the present invention, a preferred aspect of the present invention is that, when the corresponding node is present within the second home network, the home agent of the corresponding node decides to become the proxy node. As a result of the configuration, the load of transmitting the message can be reduced and a suitable processing node can be discovered.

In addition, in the proxy node of the present invention, a preferred aspect of the present invention is that, when a HMIP that is a local mobility scheme is used in the data communication system, a router that is an entrance and an exit of a hierarchical structure is decided as the proxy node. As a result of the configuration, the effort of discovering the proxy node is eliminated and a suitable processing node can be discovered.

In addition, in the proxy node of the present invention, a preferred aspect of the present invention is that, when the a mobile node proxy node discovering the processing node as a proxy of the mobile node and the proxy node belong to a same domain, the home agent of the corresponding node becomes the processing node. As a result of the configuration, the load of transmitting the message can be reduced and a suitable processing node can be discovered.

A proxy node of the present invention is a proxy node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method. In the node discovery method, a processing node is discovered from among the plurality of relay nodes. The processing node is a relay node positioned on a direct path between the mobile node and the corresponding node. The proxy node discovers the processing node as a proxy of the corresponding node. The proxy node includes a message generating means that generates a first message (referred to, hereinafter, as TA-Init-Request) for requesting a discovery of the processing node. The proxy node also includes a transmitting means that transmits the generated first message to the home agent of the mobile node. As a result of the configuration, the corresponding node side can also prompt the discovery of the processing node.

A mobile node of the present invention is a mobile node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method. In the node discovery method, a processing node is discovered from among the plurality of relay nodes. The processing node is a relay node positioned on a direct path between the mobile node and the corresponding node. The mobile node includes a message generating means that generates a first message (referred to, hereinafter, as TA-Init-Request) for requesting a discovery of the processing node. The mobile node also includes a transmitting means that transmits the generated first message to a first proxy node that discovers the processing node as a proxy of the mobile node. As a result of the configuration, a TA that can provide a more optimal data path can be detected while protecting location privacy of the MN.

In addition, in the mobile node of the present invention, a preferred aspect of the present invention is that the mobile node further includes a receiving means that receives a second message (referred to, hereinafter, as TA-Disc-Response) including address information of the relay node that can be the processing node. As a result of the configuration, the mobile node can select a suitable processing node.

In addition, in the mobile node of the present invention, a preferred aspect of the present invention is that, when the corresponding node is present within the second home network, the home agent of the corresponding node decides to become a second proxy node that discovers the processing node as a proxy of the corresponding node. As a result of the configuration, the load of transmitting the message can be reduced and a suitable processing node can be discovered.

In addition, in the mobile node of the present invention, a preferred aspect of the present invention is that, when a HMIP that is a local mobility scheme is used in the data communication system, a router that is an entrance and an exit of a hierarchical structure is decided as a second proxy node that discovers the processing node as a proxy of the corresponding node. As a result of the configuration, the effort of discovering the proxy node is eliminated and a suitable processing node can be discovered.

In addition, in the mobile node of the present invention, a preferred aspect of the present invention is that, when the first proxy node and the second proxy node that discovers the processing node as a proxy of the corresponding node belong to a same domain, the home agent of the corresponding node becomes the processing node. As a result of the configuration, the load of transmitting the message can be reduced and a suitable processing node can be discovered.

A mobile node of the present invention is a mobile node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method. In the node discovery method, a processing node is discovered from among the plurality of relay nodes. The processing node is a relay node positioned on a direct path between the mobile node and the corresponding node. The corresponding node includes a message generating means that generates a first message (referred to, hereinafter, as TA-Init-Request) for requesting a discovery of the processing node. The mobile node also includes a transmitting means that transmits the generated first message to a proxy node that discovers the processing node as a proxy of the corresponding node. As a result of the configuration, the corresponding node side can also prompt the discovery of the processing node

In addition, in the corresponding node of the present invention, a preferred aspect of the present invention is that the corresponding node further includes a receiving means that receives a second message (referred to, hereinafter, as TA-Disc-Response) including address information of the relay node that can be the processing node. As a result of the configuration, the corresponding node can select a suitable processing node.

A home agent of the present invention is a home agent of a corresponding node that, in a data communication system in which a mobile node connected to a first network and the corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including the home agent of the corresponding node, is used in a node discovery method. In the node discovery method, a processing node is discovered from among the plurality of relay nodes. The processing node is a relay node positioned on a direct path between the mobile node and the corresponding node. The home agent includes a receiving means that receives a first message (referred to, hereinafter, as TA-Init-Request) for requesting a discovery of the processing node from a first proxy node that is a proxy node that discovers the processing node as a proxy of the mobile node. The home agent also includes a message generating means that generates a second message (referred to, hereinafter, as TA-Disc-Init) for starting the discovery of the processing node based on the received first message. The mobile node also includes a transmitting means that transmits the generated second message to a second proxy node that discovers the processing node as a proxy of the corresponding node. As a result of the configuration, a TA that can provide a more optimal data path can be detected while protecting location privacy of the MN.

In addition, in the home agent of the present invention, a preferred aspect of the present invention is that the home agent further includes a controlling means that decides the second proxy node based on information (referred to, hereinafter, as an entry) for deciding the second proxy, generated in advance, and information included in the first message. The transmitting means transmits the second message to the decided second proxy node. As a result of the configuration, a suitable processing node can be decided.

In addition, in the home agent of the present invention, a preferred aspect of the present invention is that, when the controlling means judges that the corresponding node is present within the second home network, the controlling means decides that the home agent itself will become the second proxy node. As a result of the configuration, the load of transmitting the message can be reduced and a suitable processing node can be discovered.

In addition, in the home agent of the present invention, a preferred aspect of the present invention is that, when a HMIP that is a local mobility scheme is used in the data communication system, a router that is an entrance and an exit of a hierarchical structure becomes the second proxy node. As a result of the configuration, the effort of discovering the proxy node is eliminated and a suitable processing node can be discovered.

In addition, in the home agent of the present invention, a preferred aspect of the present invention is that, when the first proxy node and the second proxy node belong to a same domain, the home agent of the corresponding node itself becomes the processing node. As a result of the configuration, the load of transmitting the message can be reduced and a suitable processing node can be discovered.

A home agent of the present invention is a home agent of a mobile node that, in a data communication system in which the mobile node connected to a first network and a corresponding node that is a correspondence partner of the mobile node and connected to a second network communicate via a plurality of relay nodes disposed within an internetwork including the first network, the second network, a first home network that is a home network of the mobile node including the home agent of the mobile node and a second home network that is a home network of the corresponding node including a home agent of the corresponding node, is used in a node discovery method. In the node discovery method, a processing node is discovered from among the plurality of relay nodes. The processing node is a relay node positioned on a direct path between the mobile node and the corresponding node. The home agent includes a receiving means that receives a first message (referred to, hereinafter, as TA-Init-Request) for requesting a discovery of the processing node from a first proxy node that is a proxy node that discovers the processing node as a proxy of the corresponding node. The home agent also includes a message generating means that generates a second message (referred to, hereinafter, as TA-Disc-Init) for starting the discovery of the processing node based on the received first message. The mobile node also includes a transmitting means that transmits the generated second message to a second proxy node that discovers the processing node as a proxy of the mobile node. As a result of the configuration, the corresponding node side can also prompt the discovery of the processing node.

The node discovery method of the present invention, the proxy node used in the method, the mobile node used in the method, the corresponding node used in the method, and the home agent used in the method are configured as described above. In the mobile IPv6, a TA that can provide a quasi-optimal data path can be detected to acquire the quasi-optimal path while protecting location privacy of the MN.

### BRIEF DESCRIPTION OF THE DRAWINGS

FIG. 1 is a block diagram of an example of a configuration of a data communication system according to a first embodiment of the present invention;

FIG. 2 is a block diagram of an example of a configuration of a TA Next Steps In Signaling (NSIS) protocol according to the first embodiment of the invention;

FIG. 3 is a sequence chart used to explain an example of a sequence in which information on an address of a proxy TA Entity (pTAE) 2 is acquired according to the first embodiment of the invention;

FIG. 4 is a sequence chart used to explain an example of a sequence in which a TA is decided using a decided pTAE according to the first embodiment of the invention;

FIG. 5 is a sequence chart used to explain an example of a sequence in which an intermediate TAE positioned halfway between a pTAE 1 and the pTAE 2 is decided as the TA according to the first embodiment of the invention;

FIG. 6 is a block diagram of an example of a configuration of a mobile node (MN) according to the first embodiment of the invention;

FIG. 7 is a block diagram of an example of a configuration of the pTAE 1 according to the first embodiment of the invention;

FIG. 8 is a block diagram of an example of a configuration of the pTAE 2 according to the first embodiment;

FIG. 9 is a sequence chart used to explain an example of a sequence in which a pTAE is decided according to a second embodiment of the invention;

FIG. 10 is a block diagram of an example of a configuration of the mobile node (MN) according to the second embodiment of the invention;

FIG. 11 is a block diagram of a configuration of the data communication system according to a third embodiment of the invention;

FIG. 12 is a block diagram of a configuration of a data communication system according to a fourth embodiment of the invention;

FIG. 13 is a sequence chart of an example of a sequence in a processing node discovery process according to the fourth embodiment of the invention;

FIG. 14 is a diagram of an example of a configuration of the data communication system when the mobile node belongs to a multihomed network according to the fourth embodiment of the invention;

FIG. 15 is a block diagram of an example of a configuration of a home agent of a corresponding node (MN 1210) according to the fourth to eighth embodiment of the invention;

FIG. 16 is a block diagram of an example of a configuration the corresponding node (MN 1210) according to the fourth to eighth embodiment of the invention;

FIG. 17 is a diagram used to explain transmission and reception of a packet in a conventional data communication system;

FIG. 18A is a diagram used to explain a conventional method of deciding a TA; and

FIG. 18B is a diagram used to explain another conventional method of determining the TA.

### BEST MODE FOR CARRYING OUT THE INVENTION

### First Embodiment

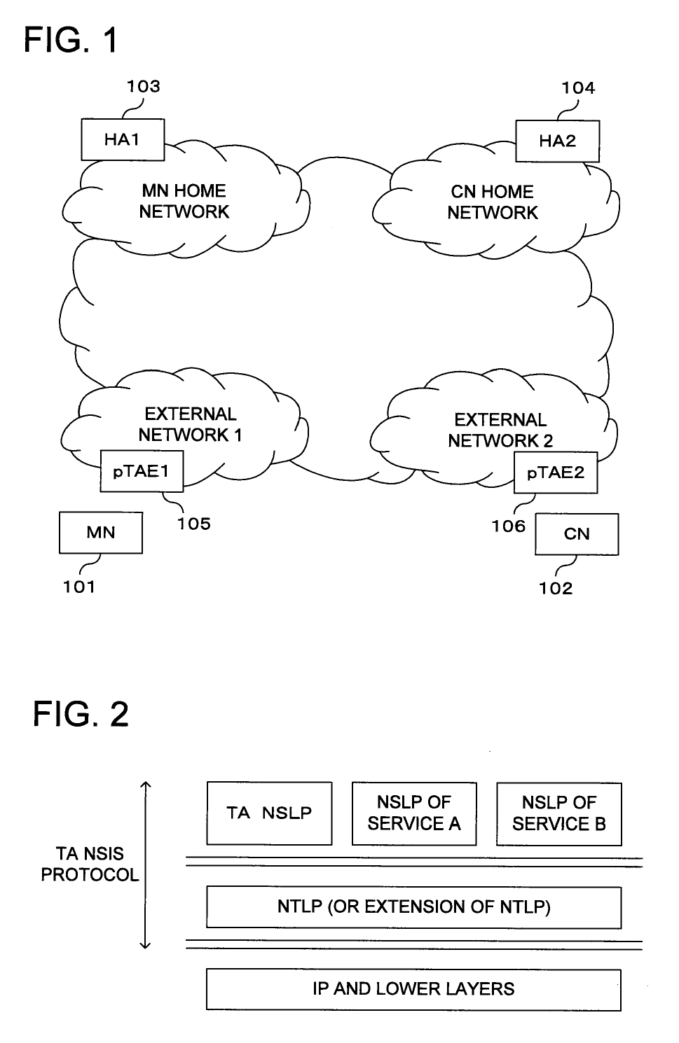

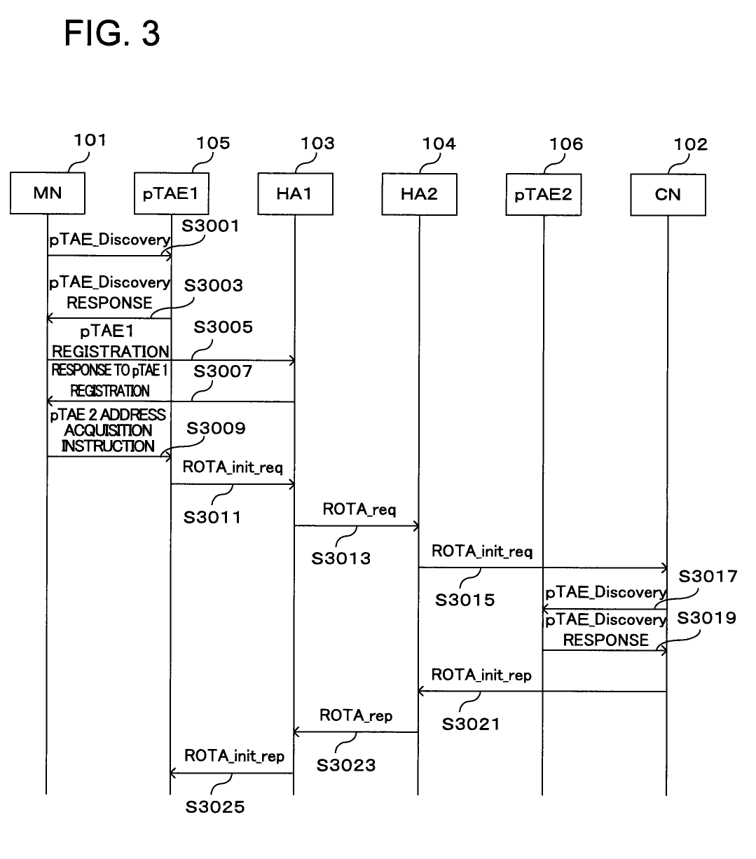

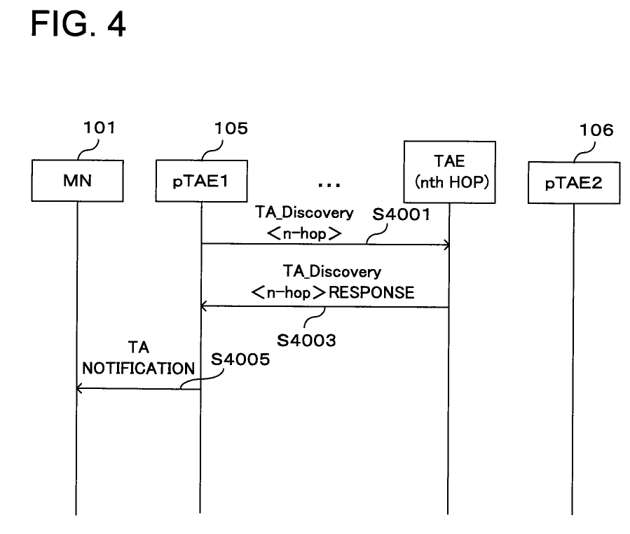

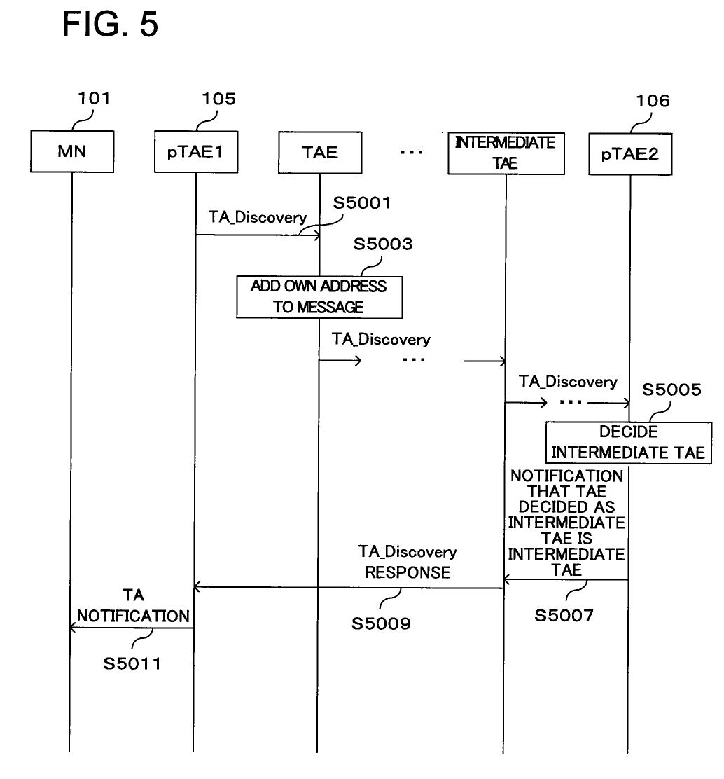

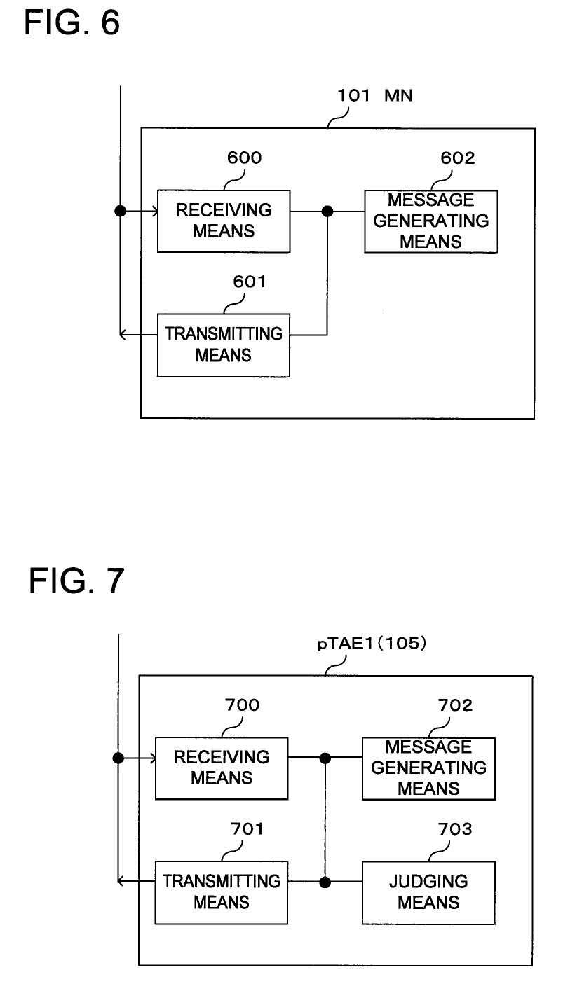

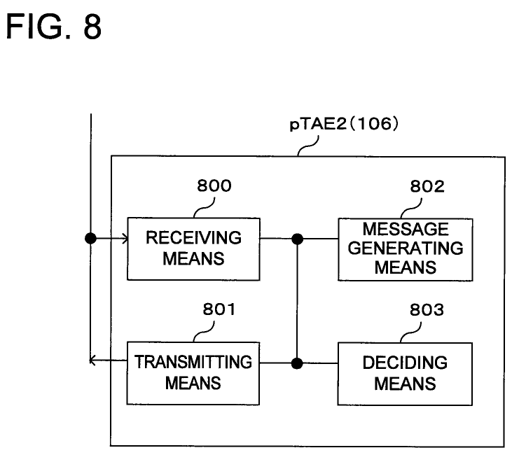

Hereinafter, a first embodiment of the present invention will be described with reference to FIG. 1 to FIG. 8. FIG. 1 is a block diagram of an example of a configuration of a data communication system according to the first embodiment of the invention. FIG. 2 is a block diagram of an example of a configuration of a TA NSIS protocol according to the first embodiment of the invention. FIG. 3 is a sequence chart used to explain an example of a sequence in which information on an address of a pTAE 2 is acquired according to the first embodiment of the invention. FIG. 4 is a sequence chart used to explain an example of a sequence in which a TA is decided using a decided pTAE according to the first embodiment of the invention. FIG. 5 is a sequence chart used to explain an example of a sequence in which an intermediate TAE positioned halfway between a pTAE 1 and the pTAE 2 is decided as the TA according to the first embodiment of the invention. FIG. 6 is a block diagram of an example of a configuration of a mobile node (MN) according to the first embodiment of the invention. FIG. 7 is a block diagram of an example of a configuration of the pTAE 1 according to the first embodiment of the invention. FIG. 8 is a block diagram of an example of a configuration of the pTAE 2 according to the first embodiment.

In the invention, a node having TA functionality is placed within an internetwork. A TA (equivalent to the above-mentioned processing node) providing a quasi-optimal path is detected using a signaling message. The node having the TA functionality has a protocol including a function for processing the signaling message used for TA detection and a function for setting the TA. The protocol is an extension of NSIS protocol described in Non-patent Document 3, above. In the invention, the protocol is referred to as a TA NSIS protocol. A configuration of the TA NSIS protocol is shown in FIG. 2. The TA NSIS protocol is a transport-layer protocol, as is the NSIS protocol, and includes two layers, a NSIS transport layer protocol (NTLP) or an extension thereof and a NSIS signaling layer protocol (NSLP). In particular, the TA NSIS protocol has a TA NSLP in the NSLP layer. In the invention, a function that can perform the TA NSIS protocol within the node having the TA functionality is referred to as a TA entity (TAE). In the invention, the node itself having the TA functionality may be referred to as the TAE.

The first embodiment of the invention will be described with reference to FIG. 1. A MN 101 and a Corresponding Node (CN) 102 are mobile nodes supporting the mobile IPv6. The home agents of the MN 101 and the CN 102 are respectively HA 1 (103) and HA 2 (104). Currently, the MN 101 and the CN 102 do not know each other's CoA. The MN 101 transmits a data packet from its own Home Address (HoA) to the HoA of the CN 102. Here, the MN 101 starts a TA retrieval to transmit the data packet to the CN 102 using a quasi-optimal path while hiding the CoA of the MN 101 itself.

Procedures of the TA retrieval are as follows. First, proxy TAE (pTAE) that transmit and receive a message used for the TA retrieval in place of the MN 101 and the CN 102 are retrieved (the pTAE of the MN 101 and the CN 102 are respectively pTAE 1 [105] and pTAE 2 [106]). Then, the TA is determined as a result of a message used for the TA retrieval (TA_Discovery message) being transmitted and received between the pTAE 1 (105) and the pTAE 2 (106). The pTAE is set because, if a node directly transmits and receives the TA_Discovery message, the node will inform the other node of its own CoA and location privacy cannot be preserved. The TA_Discovery message is a TA NSLP message. A route alert option (RAO) is added to the TA_Discovery message, as is added to other NSLP messages of the NSIS. Therefore, the TA_Discovery message is intercepted by each TAE present on a path through which the TA_Discovery message passes.

Herebelow, details of a TA retrieval method will be described. First, an example of a method in which the MN 101 and the CN 102 respectively decide the pTAE 1 (105) and the pTAE 2 (106) and the pTAE translate each other's address will be described with reference to FIG. 3. First, the MN 101 retrieves the pTAE 1 (105). As a method for retrieving the pTAE 1 (105), for example, a following method can be considered. A message (pTAE_Discovery) used for the pTAE retrieval is transmitted to an arbitrary node (such as the HA 1 [103] of the MN 101), for example, and nth TAE becomes the pTAE (Step S3001). Here, the pTAE_Discovery is the TA NSLP message. The RAO is added to the pTAE_Discovery, as is added to the other NSLP messages of the NSIS. Therefore, the pTAE-Discovery is intercepted by each TAE present on the path through which the pTAE-Discovery passes.

As a method in which the nth TAE becomes the pTAE, a method in which a “pTAE_Discovery <n-hop>” is transmitted can be considered. The “pTAE_Discovery <n-hop>” is the pTAE_Discovery to which an n-hop option is added. The pTAE_Discovery <n-hop> is a message indicating that the pTAE_Discovery is transmitted to the nth TAE and the nth TAE becomes the pTAE. For example, if the pTAE_Discovery <n-hop> is a pTAE_Discovery <1-hop>, the first TAE from the MN 101 that is the source becomes the receiver of the pTAE_Discovery <1-hop>. This TAE becomes the pTAE 1 (105).

However, when the nth TAE is not present between the MN 101 and the arbitrary destination, the TAE that is the destination (the TAE closest to the destination when the destination is not a TAE) becomes the receiver. The pTAE 1 (105) returns a pTAE_Discovery response to the MN 101, thereby informing the MN 101 that pTAE 1 (105) itself is the pTAE 1 (105) (Step S3003). The pTAE_Discovery response can be returned by the path over which the pTAE_Discovery has passed being followed in reverse as, for example, with the RESPONSE message of the QoS NSLP of the NSIS. Alternatively, the pTAE_Discovery response can be returned directly to the MN 101. A trust relationship, such as authentication being performed, can be established between the MN 101 and the pTAE 1 (105) by the pTAE_Discovery and the pTAE_Discovery response. As another method for retrieving the pTAE 1 (105), a method using an existing method, such as a candidate access router discovery (CARD) (refer to Non-patent Document 4), can be considered.

Next, the MN 101 registers the pTAE 1 (105) to the HA 1 (103) (Step S3005) and establishes the trust relationship between the pTAE 1 (105) and the HA 1 (103). In other words, the HA 1 (103) can trust the message sent from the pTAE 1 (105) and process the message. The same also applies when the HA 1 (103) sends a message to the pTAE 1 (105). The HA 1 (103) to which the pTAE 1 (105) has been registered responds to the MN 101 to inform the MN 101 of registration completion (Step S3007).

Then, the MN 101 prompts the retrieved pTAE 1 (105) to acquire an address of the pTAE (pTAE 2 [106]) of the CN 102. As the procedure, a method is used in which, for example, a message called ROTA_init_req and a message called ROTA_init_rep, described in the above-described Non-patent Document 2, are used. The procedure will be described with reference to FIG. 3. First, the MN 101 instructs the pTAE 1 (105) to transmit the ROTA_init_req to the HA 1 (103) and acquire the address of the pTAE 2 (106) (Step S3009). The pTAE 1 (105) transmits the ROTA_init_req to the HA 1 (103) (Step S3011).

Next, the HA 1 (103) transmits a ROTA_-req to the HA 2 (104) (Step S3013). The HA 2 (104) transmits the ROTA_init_req to the CN 102 (Step S3015). The address of the pTAE 1 (105) is included in the messages. The CN 102 that has received the ROTA_init_req retrieves the pTAE 2 (106). A same method as that used when the MN 101 retrieves the pTAE 1 (105) is used as the retrieval method (Step S3017 and Step S3019). The CN 102 can retrieve the pTAE 2 (106) beforehand, without waiting to receive the ROTA_init_req.

Next, the CN 102 transmits the ROTA_init_rep to the HA 2 (104) (Step S3021). The HA 2 (104) transmits a ROTA_rep to the HA 1 (103) (Step S3023). Furthermore, the HA 1 (103) transmits the ROTA_init_rep to the pTAE 1 (105) (Step S3025). The address of the pTAE 2 (106) is included in the ROTA_init_rep and the ROTA_rep. The pTAE 1 (105) that has received the ROTA_init_rep can transmit a message notifying the MN 101 that the address of the pTAE 2 (106) has been received. However, the pTAE 1 (105) must not send the address of the pTAE 2 (106) to the MN 101 because of risk that the MN 101 will find out the location of the CN 102.

Next, a method of deciding the TA of the MN 101 using the decided pTAE will be described with reference to FIG. 4. First, the pTAE 1 (105) that has received the ROTA_init_rep transmits a TA_Discovery <n-hop> to the pTAE 2 (106) (Step S4001). The TA_Discovery <n-hop> is a message indicating that the TA_Discovery is sent to the nth TAE and the nth TAE becomes the TA. For example, if the TA_Discovery <n-hop> is TA_Discovery <2-hop>, the second TAE from the pTAE 1 (105) that is the source becomes the receiver of the TA_Discovery <2-hop>. This TAE becomes the TA. However, when the nth TAE is not present between the pTAE 1 (105) and the arbitrary destination, the TAE immediately before the pTAE 2 (106) that is the destination becomes the receiver.

Then, the TAE of the nth hop that has received the TA_Discovery <n-hop> returns a TA_Discovery <n-hop> response to the pTAE 1 (105), declaring that the TAE of the nth hop itself is the TA (Step S4003). The pTAE 1 (105) notifies the MN 101 of the information on the TA (Step S4005). The decided TA can be used not only as the TA of the MN 101, but also as the TA of the CN 102. In this case, the information of the TA is notified to the CN 102, via the pTAE 2 (106). When the TA is used as the TA of the CN 102 and the like, from the perspective of location privacy of the MN 101 and the CN 102, the TA is preferably far from both an external network 1 and an external network 2. The MN 101 belongs to the external network 1. The CN 102 belongs to the external network 2. In this case, a TAE positioned about halfway between the pTAE 1 (105) and the pTAE 2 (106) can become the TA. The method is described with reference to FIG. 5.

First, the pTAE 1 (105) that has received the ROTA_init_rep transmits the TA_Discovery to the pTAE 2 (106) (Step S5001). Each TAE that has intercepted the TA_Discovery adds its own address to the TA_Discovery (Step S5003). The pTAE 2 (106) that has received the TA_Discovery confirms an order of the added TAE addresses and decides the TAE (intermediate TAE) positioned exactly in the middle (Step S5005). When the number of added TAE addresses is an even number, either of the TAE closest to the middle is selected as the intermediate TAE. The intermediate TAE is not required to be exactly in the middle of the pTAE 1 (105) and the pTAE 2 (106). The intermediate TAE can also be a TAE that is closer to either.

The pTAE 2 (106) notifies the intermediate TAE that it is the intermediate TAE (Step S5007). The intermediate TAE returns a TA_Discovery response to the pTAE 1 (105), declaring that the intermediate TAE itself will become the TA (Step S5009). The pTAE 1 (105) notifies the MN 101 of the information of the TA (Step S5011). The message includes a “TAE hop number” field. At Step S5003, instead of the TAE adding its own address to the message, the TAE hop number can be incremented. In this case, the hop number of the intermediate TAE is calculated at Step S5005. When the pTAE 2 (106) gives notification that the intermediate TAE is the intermediate TAE at step S8007, “notification that the intermediate TAE is the intermediate TAE”<n-hop> is given. The calculated hop number is set in n.

Next, an example of a configuration of the mobile node (MN) according to the first embodiment will be described, with reference to FIG. 6. As shown in FIG. 6, the MN 101 includes a receiving means 600, a transmitting means 601, and a message generating means 602. A main process of each means is indicated below. However, the processes are not limited thereto. The message generating means 602 generates the pTAE_Discovery to extract the pTAE that discovers the TA from among the TAE, as a proxy of the MN 101. For example, to make the nth TAE from the MN 101 become the pTAE, the message generating means 602 generates the “pTAE_Discovery <n-hop>”, as described above. The “pTAE_Discovery <n-hop>” is the pTAE_Discovery to which the n-hop option has been added. When generating the pTAE_Discovery (pTAE_Discovery <n-hop>), the message generating means 602 adds the above-described RAO to the pTAE_Discovery (pTAE_Discovery <n-hop>). The message generating means 602 also generates a message prompting the pTAE 1 (105) to acquire information of the address of the pTAE 2 (106) that is the proxy node of the CN 102.

The transmitting means 601 transmits the pTAE_Discovery (pTAE_Discovery <n-hop>) generated by the message generating means 602 to, for example, the HA 1 (103) of the MN 101 that can process the pTAE_Discovery (pTAE_Discovery <n-hop>). As a result, the TAE present on the path over which transmission is performed can become the pTAE. The transmitting means 601 also transmits the message for prompting the pTAE 1 (105) to acquire the information of the address of the pTAE 2 (106) that is the proxy node of the CN 102 to the pTAE 1 (105). The receiving means 600 receives a message sent by the TAE that has received the pTAE_Discovery (pTAE_Discovery <n-hop>) when the TAE judges that the TAE itself is the pTAE. The message states that the TAE itself is the pTAE 1 (105). The receiving means 600 also receives information of the decided TA and the like from the pTAE 1 (105).

Next, an example of a proxy node (pTAE 1) according to the first embodiment of the invention will described with reference to FIG. 7. As shown in FIG. 7, the pTAE 1 (105) includes a receiving means 700, a transmitting means 701, a message generating means 702, and a judging means 703. A main process of each means is indicated below. However, the processes are not limited thereto. The message generating means 702 generates the TA_Discovery for discovering the TA. As a result of the transmitting means 701 transmitting the TA_Discovery to discover the TA, as described hereafter, information of the address of the TAE on the transmission path is added to the TA_Discovery. The message generating means 702 can generate the above-mentioned TA_Discovery <n-hop> to make the nth TAE from the pTAE 1 (105) become the TA. When generating the TA_Discovery (TA_Discovery <n-hop>), the message generating means 702 adds the above-mentioned RAO to the TA_Discovery (TA_Discovery <n-hop>). The message generating means 702 also generates a message (the above-described ROTA_init_req) for acquiring the information of the address of the pTAE 2 (106).

The transmitting means 701 transmits the generated TA_Discovery (TA_Discovery <n-hop>) towards the pTAE 2 (106) that discovers the TA as the proxy of the CN 102. The transmitting means 701 transmits the generated message for acquiring the information of the address of the pTAE 2 (106) to the HA 1 (103). The transmitting means 701 also transmits the information of the decided TA to the MN 101.

The receiving means 700 receives the pTAE_Discovery <n-hop> transmitted from the MN 101 to extract the pTAE 1 (105). When the TAE that has received the transmitted TA_Discovery <n-hop> judges that the TAE itself will become the TA based on the received TA_Discovery <n-hop>, the receiving means 700 receives the message from the TAE that has made the judgment stating that the TAE itself will become the TA. When the TA_Discovery is transmitted, the receiving means 700 receives a message from the TA (intermediate TA) decided by the pTAE 2 (106) that received the transmitted TA_Discovery. The message states that the TA (intermediate TA) itself has become the TA. The receiving means 700 also receives a message from the MN 101 for acquiring address information of the pTAE 2 (106), the information of the address of the pTAE 2 (106), and the like.

The judging means 703 judges whether the pTAE 1 (105) itself is the pTAE 1 (105), based on the pTAE_Discovery <n-hop> transmitted from the MN 101 to extract the pTAE 1 (105). pTAE_Discovery <n-hop> is received by the receiving means 700. When the judging means 703 judges that the pTAE 1 (105) itself is the pTAE 1 (105), the above-described message generating means 702 generates a message stating that the pTAE 1 (105) itself is the pTAE 1 (105). The transmitting means 701 transmits the generated message to the MN 101.

Next, an example of a proxy node (pTAE 2) according to the first embodiment of the invention will be described with reference to FIG. 8. As shown in FIG. 8, the pTAE 2 (106) includes a receiving means 800, a transmitting means 801, a message generating means 802, and a deciding means 803. A main process of each means is indicated below. However, the processes are not limited thereto. The receiving means 800 receives a message for extracting the pTAE 2 (106) from the CN 102, based on a request for acquisition of the information of the address of the pTAE 2 (106) from the pTAE 1 (105). The receiving means 800 receives the TA_Discovery to which the TAE that has received the TA_Discovery for discovering the TA, transmitted from the pTAE 1 (105), adds address information of the TAE itself.

The deciding means 803 decides the TA based on the received TA_Discovery to which the address information has been added. Specifically, based on a number of pieces of address information added to the TA_Discovery, the TAE (intermediate TAE) positioned halfway between the pTAE 1 (105) and the pTAE 2 (106) is determined to be the TA. The message generating means 802 generates a message to the TAE decided as the intermediate TAE stating that the TAE is the intermediate TAE. The transmitting means 801 transmits the message stating that the TAE is the intermediate TAE, generated by the message generating means 802.

### Second Embodiment

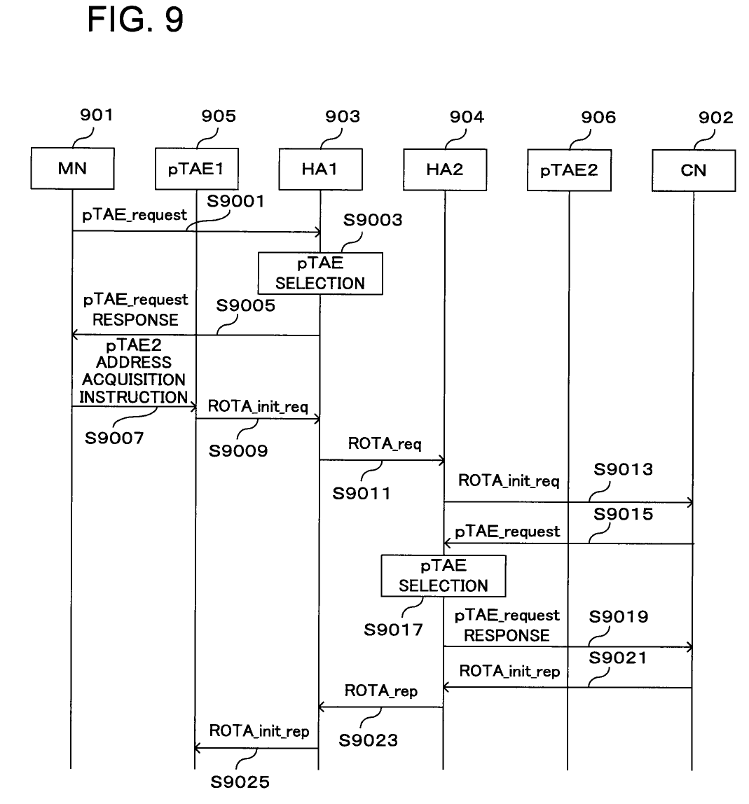

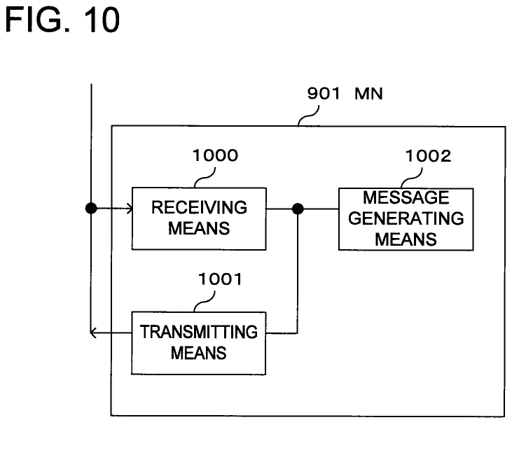

Hereinafter, a second embodiment of the present invention will be described with reference to FIG. 9 and FIG. 10. FIG. 9 is a sequence chart used to explain an example of a sequence in which the pTAE is decided according to the second embodiment of the invention. FIG. 10 is a block diagram of an example of a configuration of the mobile node (MN) according to the second embodiment of the invention.

According to the first embodiment, the MN 101 and the CN 102 directly decides the pTAE. However, the HA of the MN or the CN can also designate the pTAE. In this case, it is presumed that the HA holds information on the TAE present in each external network. The procedure will be described with reference to FIG. 9. First, a MN 901 transmits a pTAE_request to a HA 1 (903) and requests designation of the pTAE (Step S9001). The HA 1 (903) judges the external network to which the MN 901 belongs using information of the CoA of the MN 901 and selects a suitable pTAE (Step S9003). The HA 1 (903) gives notification of the pTAE by sending a pTAE_request response to the MN 901 (Step S9005).

Then, as according to the first embodiment, the MN 901 prompts the acquired pTAE 1 (905) to acquire the address of a pTAE 2 (906) that is the pTAE of the CN 902. In other words, the MN 901 instructs the pTAE 1 (905) to acquire the address of the pTAE 2 (906) by transmitting the ROTA_init_req to the HA 1 (903) (Step S9007). The pTAE 1 (905) transmits the ROTA_init_req to the HA 1 (903) (Step S9009).

Then, the HA 1 (903) transmits a ROTA_req to the HA 2 (904) (Step S9011). The HA 2 (904) transmits the ROTA_init_req to the CN 902 (Step S9013). The address of the pTAE 1 (905) is included in the messages. The CN 902 that has received the ROTA_init_req acquires the pTAE 2 (906) from the HA 2 (904). The same method as that used when the MN 901 retrieves the pTAE 1 (905) is used as the acquisition method (Step S9015 to Step S9019). The CN 902 can retrieve the pTAE 2 (906) in advance, without waiting to receive the ROTA_init_req.

Next, the CN 902 transmits the ROTA_init_rep to the HA 2 (904) (Step S9021). The HA 2 (904) transmits a ROTA_rep to the HA 1 (903) (Step S9023). Furthermore, the HA 1 (903) transmits the ROTA_init_rep to the pTAE 1 (905) (Step S9025). The address of the pTAE 2 (906) is included in the ROTA_init_rep and the ROTA_rep. The pTAE 1 (905) that has received the ROTA_init_rep can transmit a message notifying the MN 901 that the address of the pTAE 2 (906) has been acquired. However, the pTAE 1 (905) must not send the address of the pTAE 2 (906) to the MN 901 because of risk that the MN 901 will find out the location of the CN 902. The pTAE retrieved according to the first embodiment and the second embodiment can also be used as a local HA or MAP in “ROTA in scenarios with visited network support” described in Non-patent Document 2, above.

Next, an example of the mobile node (MN) according to the second embodiment will be described with reference to FIG. 10. As shown in FIG. 10, the MN 901 includes a receiving means 1000, a transmitting means 1001, and a message generating means 1002. A main process of each means is indicated below. However, the processes are not limited thereto. The message generating means 1002 generates a message requesting a designation of the pTAE that discovers the TA as a proxy of the MN 901, from among a plurality of TAE. The transmitting means 1001 transmits the message generated by the message generating means 1002 to the HA 1 (903) of the MN 901. The receiving means 1000 receives the information of the decided pTAE based on the information of the address of the MN 901 transmitted by the HA 1 (903) of the MN 901.

When the receiving means 1000 receives the information of the pTAE 1 (905), the message generating means 1002 generates the message for making the pTAE 1 (905) acquire the information of the address of the pTAE 2 (906) that is the proxy node of the CN 902, as according to the first embodiment. Then, the transmitting means 1001 transmits the generated message to the pTAE 1 (905).

The descriptions of the method of acquiring the information of the address of the pTAE 2 in the pTAE 1 according to the second embodiment and the method of deciding the TA in the pTAE 1 and the pTAE 2 according to the second embodiment are omitted because the methods are basically the same as those according to the first embodiment.

### Third Embodiment

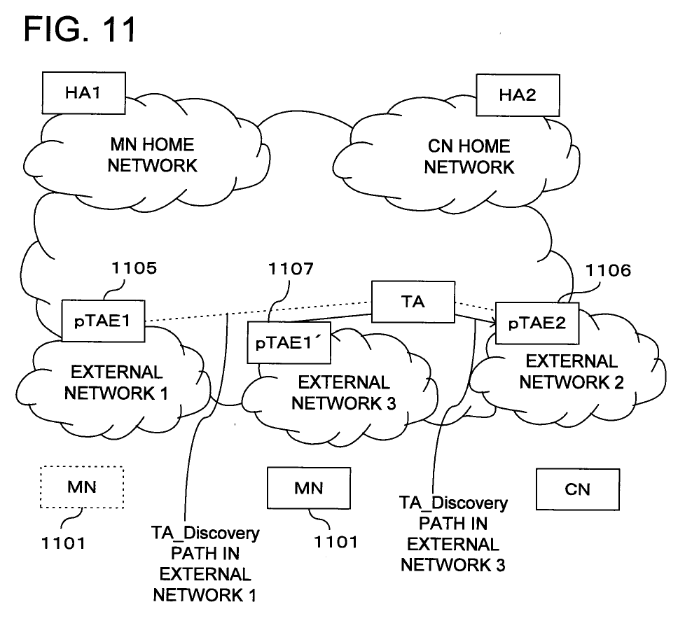

In the first embodiment and the second embodiment, the case which the MN moves to another network will be described with reference to FIG. 11. Here, an MN 1101 moves from the external network 1 to an external network 3. At this time, the MN 1101 again selects a pTAE 1 (1105) that is the pTAE, using the method described according to the first embodiment or the second embodiment. The pTAE 1 (1105) transmits a TA_Discovery message or a TA_Discovery <n-hop> message (referred to, hereafter, as simply the TA_Discovery message) to the pTAE 2 (1106). At this time, the path used when the TA_Discovery message is transmitted in the external network 1 and the path used when the TA_Discovery message is transmitted in the external network 3 intersects and converges. When the first TAE (crossover TAE) of the converged path is before the TA used by the MN 1101 in the external network 1 (referred to, hereafter, as the current TA) or, in other words, is on the MN 1101 side, the MN 1101 continues to use the current TA even in the external network 3.

In a method of detecting a positional relationship between the crossover TAE and the current TA, for example, when a pTAE 1′ (1107) that is the pTAE of the MN 1101 in the external network 3 transmits the TA_Discovery message, if the current TA intercepts the TA_Discovery message, the current TA declares that the current TA itself is the TA by returning a response message for the TA_Discovery message to the pTAE 1′ (1107). If the current TA does not intercept the TA_Discovery message or, in other words, when the current TA is not present on the path of the TA_Discovery message in the external network 3, a new TA is selected by the method described according to the first embodiment.

As another example of the method of detecting the positional relationship between the crossover TAE and the current TA, when the TA is selected using the TA_Discovery message, all TAE present between the pTAE 1 (1105) and the selected TA are notified that the TA has been decided. Then, when the pTAE 1′ (1107) transmits the TA_Discovery message in the external network 3, if the crossover TAE detects that the crossover TAE itself is closer to the pTAE 1′ (1107) side than the current TA, the crossover TAE stops the transfer of the TA_Discovery message and transmits a message stating “continue using the current TA” to the pTAE 1′ (1107).

If the crossover TAE is not present closer to the pTAE 1′ (1107) side than the current TA, the transfer of the TA_Discovery message is continued and a new TA is selected. To notify the TAE between the pTAE 1 (1105) and the TA that the TA has been decided, for example, a notification can be given when the TA returns the response message for the TA_Discovery message. This is because, in adherence to the NSIS method, the response message passes through a path that is a direct opposite of that of the TA_Discovery message, and all TAE present on the path between the pTAE 1 (1105) and the TA can receive the response message.

Because there are problems such as a processing load being applied when the TA discovery process, such as that described above, is performed every time the MN 1101 moves, the TA used before the movement can be used as is at the movement destination, without the TA discovery process being performed.

Here, an example of a process performed by the MN 1101 according to the third embodiment will be described. As described above, when the MN 1101 moves from the external network 1 and connects to the external network 3, a first path (the TA_Discovery path in the external network 1 shown in FIG. 11) and a second path (the TA_Discovery path in the external network 3 shown in FIG. 11) intersects and converges. The TA_Discovery message transmitted to discover the TA when the MN 1101 is connected to the external network 1 before moving passes through the first path. The TA_Discovery message transmitted to discover the TA in the external network 3 that is the new connection destination passes through the second path. The TAE (not shown) present immediately after the convergence of the first path and the second path receives the TA_Discovery message transmitted by the transmitting means (not shown) to discover the TA in the external network 3 that is the new connection destination. If the receiving means (not shown) of the MN 1101 receives the message from the TAE (not shown) stating that the TA discovered when the MN 1101 had been connected to the external network 1 before moving should be continuously used as the processing node, the judging means (not shown) of the MN 1101 decides to continuously use the TA from before the movement as the processing node, based on the message received by the receiving means (not shown).

Next, an example of a process performed by the crossover TAE according to the third embodiment will be described. As described above, the first path (the TA_Discovery path in the external network 1 shown in FIG. 11) and the second path (the TA_Discovery path in the external network 3 shown in FIG. 11) intersects and converges. The TA_Discovery message transmitted to discover the TA when the MN 1101 is connected to the external network 1 before moving passes through the first path. The TA_Discovery message transmitted to discover the TA in the external network 3 that is the new connection destination passes through the second path. The judging means of the TAE (not shown) present immediately after the convergence of the first path and the second path judges whether the TAE (not shown) is positioned closer to the MN 1101 side than the TA in the external network 1 on the converged path. When the judging means of the TAE (not shown) judges that the TAE is positioned closer to the MN 1101 side than the TA in the external network on the converged path, the message generating means of the TAE (not shown) generates the message stating that the TA in the external network 1 should be continuously used as the TA. The transmitting means of the TAE (not shown) transmits the generated message to the MN 1101.

### Fourth Embodiment

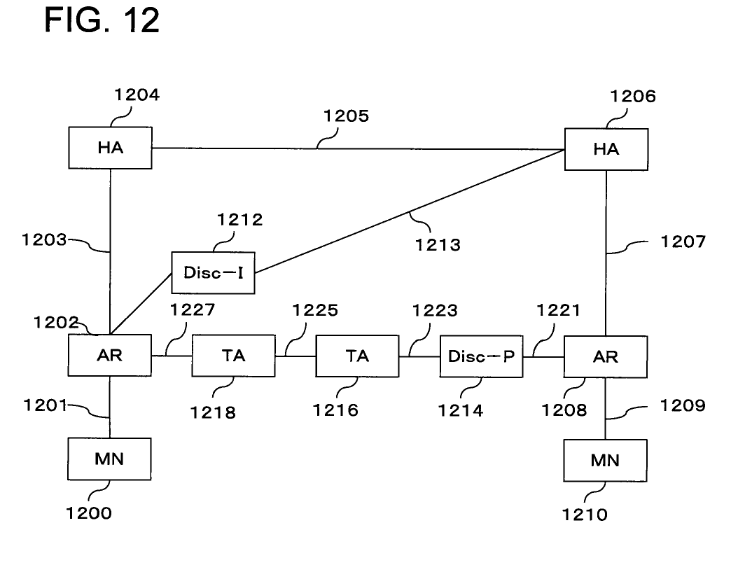

An example of a network configuration supporting the invention is shown in FIG. 12. A MN 1200 is connected to a network via an access router, such as an AR 1202. The AR 1202 provides MN 1200 a connection to a home domain and a HA, such as a HA 1204. Similarly, a MN 1210 is connected to the network via another access router, such as an AR 1208, and can be connected to a HA 1206. The configurations of the mobile node (MN), a proxy node of the mobile node (MN 1200), and a proxy node of a corresponding node (MN 1210) according to embodiments subsequent to the fourth embodiment are the same as the MN, the pTAE 1, and the pTAE 2 of the first embodiment. Therefore, when the mobile node (MN), the proxy node of the mobile node (MN 1200), and the proxy node of the corresponding node (MN 1210) are described, FIG. 6 to FIG. 8 are referenced.

A direct path is present between the MN 1200 and the MN 1210, via links 1201, 1227, 1225, 1223, 1221, and 1209. The invention facilitates the discovery of the TA on the direct path, such as a TA 1216 and a TA 1218.

At least one Disc-I (Discovery Initiator) 1212 is present near the MN 1200 and belongs to the same domain or the same subnet. The node helps the MN 1200 start the TA discovery procedure so that the MN 1200 is not required to reveal its own Identification (ID) to other nodes.

Another node involved in the TA discovery is a Disc-P (Discovery Proxy) 1214. The Disc-P 1214 locates near the MN 1210 and is on the direct path from the MN 1210 to the MN 1200. The node starts an on-path signaling application for TA discovery and is equivalent to the pTAE according to the first to third embodiments.

It is clear to a person skilled in the art that an actual network has different configurations, such as less or more links or more network nodes than the nodes shown in FIG. 12. The principle of the invention is not affected.

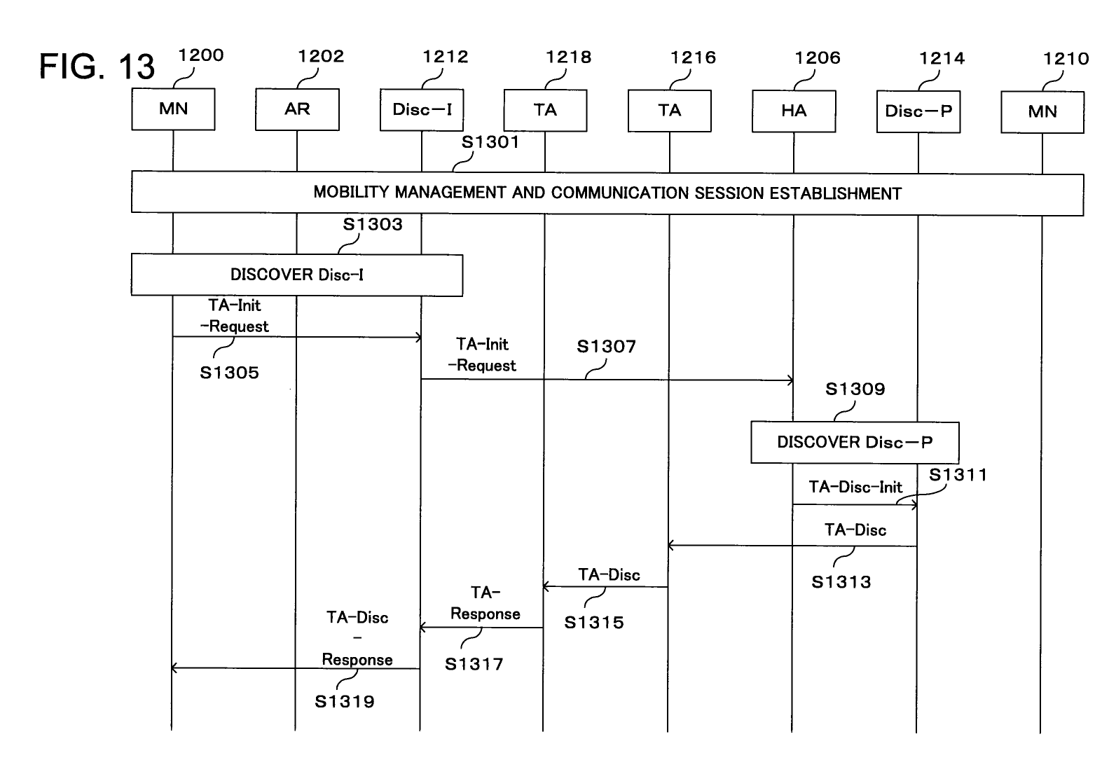

FIG. 13 is an example of a signaling sequence indicating the kind of process performed by the network node to discover a suitable TA. As shown at Step S1301, when the MN 1200 and the MN 1201 move to new locations (positions), a mobility managing procedure is performed and a communication session is established (mobility management and communication session establishment). The procedure includes, for example, acquiring the CoA, registering the CoA in the HA, and performing upper layer signaling for session establishment, such as session initiation protocol (SIP) signaling. It is clear to a person skilled in the art that, when the mobile node is outside of the home domain, the communication session is performed over the HA 1204 and the HA 1206.

When the MN 1200 attempts to construct an optimal path with a corresponding node, such as the MN 1210, the MN 1200 starts the TA discovery procedure. The MN 1200 starts the procedure with finding the Disc-I (1212) (Disc-I discovery) (Step S1303). Because location privacy is desired, the MN 1200 is required to use the Disc-I (1212) to hide the actual ID of the MN 1200. However, depending on the policy of the MN 1200, the MN 1200 itself can serve as the Disc-I.

The location of the Disc-I (1212) has no special requirements. During deployment, a Disc-I (1212) can be configured for each domain or for each subnet. In such cases, the position of the Disc-I (1212) is static, and could be configured to the MN 1200 using conventional method. The position is, for example, embedded in a router announcement (router notification), obtained by a Dynamic Host Configuration Protocol (DHCP) message, or is a pre-defined link-local address. In such cases, Step S1303 is trivial to the MN 1200. For example, when the MN 1200 is in the home domain, the MN 1200 uses one of the HA in the domain as the Disc-I.

The Disc-I (1212) can be disposed in an ad-hoc manner. In this case, the MN 1200 is required to perform the discovery procedure. For example, the MN 1200 can perform a Domain Name System (DNS) Query for a pre-defined Disc-I (1212) name or transmit a Query to a pre-configured multicast address. It is clear to a person skilled in the art that the above-described methods require no major changes at the MN 1200. The methods can be achieved by a software module being run over protocols available in most MN.

When the MN 1200 acquires the address of the Disc-I (1212), the MN 1200 (transmitting means 601) transmits a TA-Init-Request towards the Disc-I (1212) (Step S1305). The message generating means 602 generates the TA-Init-Request message. An example of a TA-Init-Request message format is shown below.

TA-Init-Request: =[Requester Address]
[Target Address]
[Policy Data]

The “Requester Address” includes a CoA 1 that is the CoA of a mobile node, such as the MN 1200. However, in certain cases, for example, when the CoA 1 is formed using an interface Media Access Control (MAC) address, the CoA 1 may also reveal the ID of the mobile node. Therefore the mobile node can decide the actual information to be inserted into the “RequesterAddress” field. For example, the MN 1200 (message generating means 602) can insert prefix information of the subnet or the address of the AR 1202 into the field, or leave the field blank.

The “Target Address” includes the address of the node on the other end of the communication. When the node is a mobile node, such as the MN 1210, the address is the home address of the mobile node, such as HoA 2. However, the MN 1200 is not required to distinguish these differences.

The “Policy Data” includes information related to TA discovery and necessary control. For example, the information includes TA selection criteria, such as supported tunneling methods, encryption schemes, and other capability requirements. The information also includes, for example, session information so that a response can be easily matched with the request.

The TA-Init-Request message is directly transmitted to the Disc-I (1212) using normal IP encapsulation. Prior connection is not necessary between the MN 1200 and the Disc-I (1212). For example, the Disc-I (1212) can listen on a well-known port. The MN 1200 addresses the TA-Init-Request message to the address of the Disc-I (1212) and the particular port number. When the MN 1200 itself is the Disc-I, Step S1303 and Step S1305 are not required.

When the Disc-I (1212) (receiving means 700) receives the TA-Init-Request message, the Disc-I (1212) performs a pre-defined process. For example, the Disc-I (1212) (judging means 703) checks whether the MN 1200 transmitting the TA-Init-Request message is legitimate. For example, the Disc-I (1212) confirms whether the MN 1200 is under the domain of the Disc-I (1212). It is clear to a person skilled in the art that other types of processes are performed, such as recognizing that the MN 1200 is legitimate using the information entered into the “Policy Data”.

The Disc-I (1212) (judging means 703) checks the “Requester Address” field of the received TA-Init-Request message. When the “Requester Address” includes the subnet prefix or is blank, the Disc-I (1212) (judging means 703) determines a suitable address to fill in the “Requester Address”. For example, when the “Requester Address” includes the subnet prefix, the Disc-I (1212) consults its local information, such as a routing table, and acquires a default gateway or a subnet router address. When the “Requester Address” is blank, the Disc-I (1212) checks the source address, such as the CoA 1 of the MN 1200, and attempts to find the default gateway for the address. When the MN 1200 itself is the Disc-I, the MN 1200 directly fills in the request address and the target address.

The “Policy Data” can include the address of the node to which the discovery response is sent. If there is no such address, the response for the TA discovery is transmitted to the Disc-I (1212).

When the Disc-I (1212) (judging means 703) updates the “Requester Address”, the Disc-I (1212) (transmitting means 701) transfers the TA-Init-Request message to a pre-defined address related to the “Target Address” (Step S1307). For example, if the “Target Address” indicates the home address of the MN 1210, the Disc-I (1212) (transmitting means 701) transfers the message towards a special anycast address related to the domain. The network node supporting the TA-Init-Request message can recognize an anycast address such as this and can receive the message. For example, the anycast address is a home agent anycast address defined in Non-patent Document 5. Therefore, the home agent of the MN 1210, HA 1206, receives the message. If the MN 1210 is in the home domain, or is a fixed node that does not support the Mobile IP (MIP), the TA-Init-Request message is intercepted by a node that can recognize the anycast address in its domain. Therefore, the invention can support both mobile end hosts and fixed end nodes. In addition, the Disc-I can also send the TA-Init-Request message to the address of the HA 1206. A method of acquiring the address of the HA 1206 is, for example, that Disc-I acquires the address of the HA 1206 via the HA 1204 using a Dynamic Home Agent Address Discovery (DHAAD) extension or the DNS, as described in Non-patent Document 2. The Disc-I can also request the HA 1204 to transfer the TA-Init-Request message to the HA 1206.

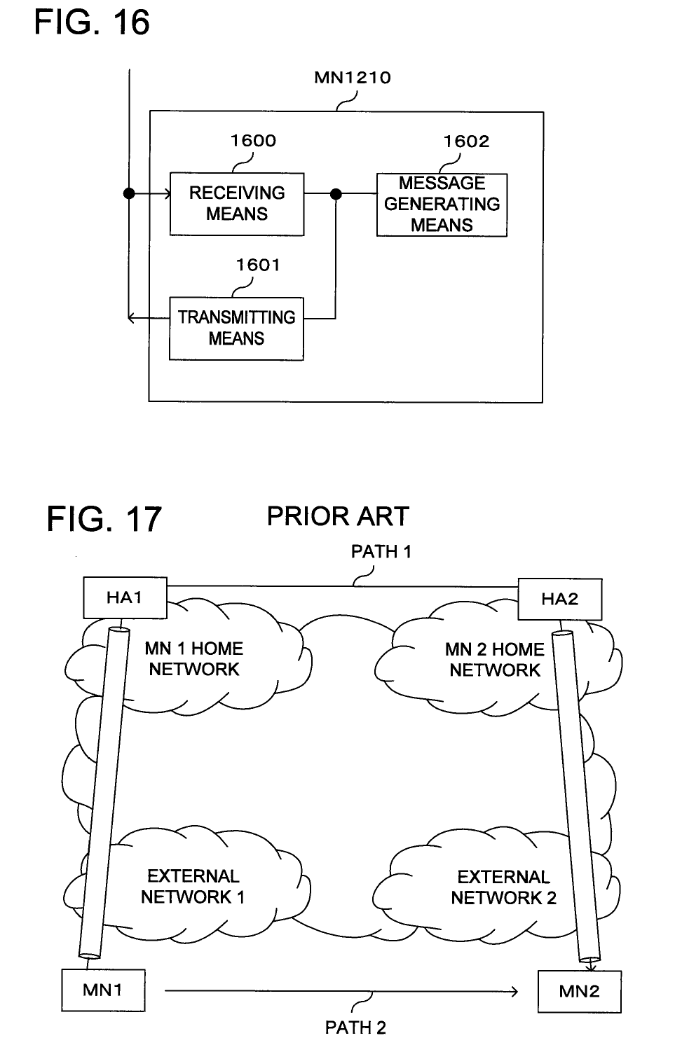

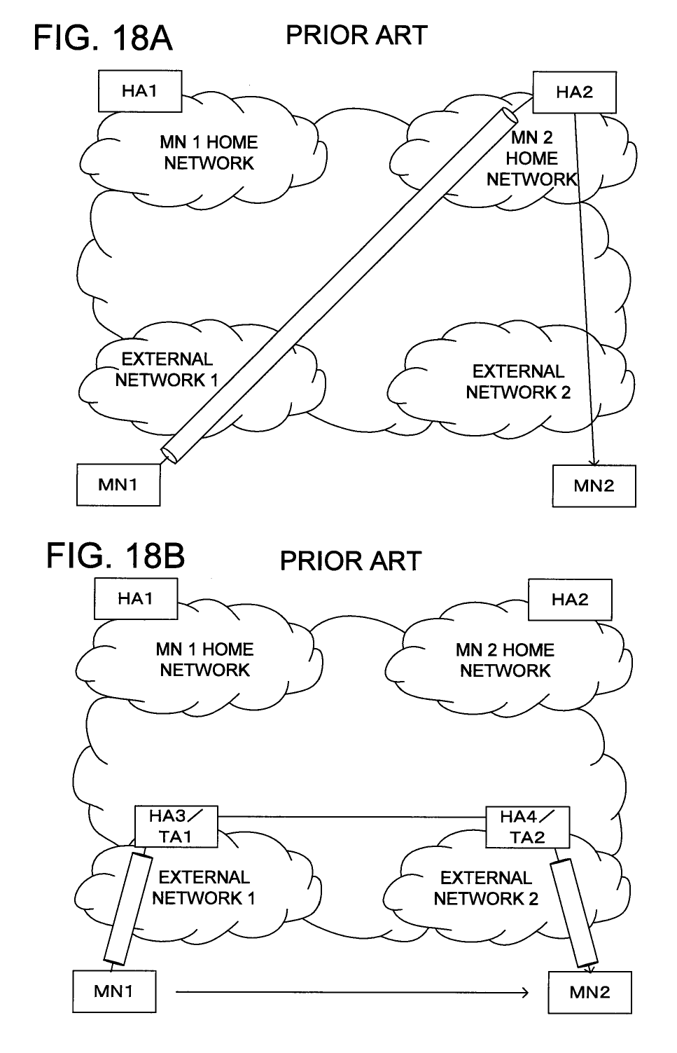

When a support node, such as the HA 1206, receives the TA-Init-Request message, the receiving node decides the Disc-P based on the information in the “Requester Address” and the “Target Address” (Disc-P discovery) (S1309). The Disc-P is on a direct data path from the “Target Address” towards the “Requester Address”. To find the suitable Disc-P, the receiving node, such as the HA 1206, maintains a special entry (in a storing means, not shown) regarding the communication end, such as the MN 1210. Here, an example of a configuration of the HA 1206 and a configuration of the MN 1210 will be described with reference to FIG. 15 and FIG. 16. As shown in FIG. 15, the HA 1206 includes a receiving means 1500, a transmitting means 1501, a message generating means 1502, and a controlling means 1503. The receiving means 1500 receives messages from an outside source and the like. The transmitting means 1501 transmits messages to an outside destination and the like. The message generating means 1502 processes the message from the outside source and generates the message to be transmitted to the outside destination. The controlling means 1503 performs internal control of the HA 1206. Constituent elements are not limited thereto.

As shown in FIG. 16, the MN 1210 includes a receiving means 1600, a transmitting means 1601, and a message generating means 1602. The receiving means 1600 receives messages from an outside source and the like. The transmitting means 1601 transmits messages to an outside destination and the like. The message generating means 1602 processes the message from the outside source, generates the message to be transmitted to the outside destination, and performs internal control of the MN 1210. Constituent elements are not limited thereto. Based on a configuration such as this, for example, when the MN 1210 enters a new domain other than the home domain, the MN 1210 (message generating means 1602) acquires local Disc-P information and registers the acquired information to the receiving node within the home domain, such as the HA 1206. Upon receiving a registration message such as this, the HA 1206 (controlling means 1503) generates a new entry or updates an existing entry. An example of a registration message format shown below.

Register-Disc-P: =[Home Address]
[Local Disc-P List]
[Policy Data]

The “Home Address” includes the home address of the MN 1210, HoA 2.

The “Local Disc-P List” includes information on the Disc-P known by the MN 1210. There are several methods by which the MN 1210 acquires information on the Disc-P. For example, the AR 1208 can announce its capability of Disc-P during the router announcement. Then, the MN 1210 (message generating means 1602) can include the address of the node in the “Local Disc-P List”.

The MN 1210 can also acquire such information as a part of the DHCP procedure. In this case, the DHCP server would be either preconfigured with the Disc-P address or allowed to dynamic to access a backend server for such information.

When the Disc-P information is not present in either the router announcement or the DHCP message that are the above-described messages, or when the local policy of the HA 1206 and the policy data of the TA-Init-Request instructs that a new Disc-P be discovered, the MN 1210 (message generating means 1602) performs a local discovery process to find the Disc-P within the domain. For example, the MN 1210 can perform a local DNS Query using a known name.

It is clear to a person skilled in the art that the MN 1210 will discover a plurality of Disc-P in the local domain. In such case, the MN 1210 (message generating means 1602) includes special information in the “Policy Data” regarding the Disc-P in the “Local Disc-P List”. For example, the MN 1210 includes a certain destination prefix or includes that a certain Disc-P should be used. It is clear to a person skilled in the art that the information could be overlapping, i.e. multiple Disc-P could be serving the same destination address.

The “Policy Data” includes special information for security protection of the registration message. The Register-Disc-P message includes information revealing the location of the MN 1210. As a result, the information is required to be protected, such as by encoding or authentication. Therefore, the “Policy Data” can include a message authentication code for, for example, preventing an attack from a third-party node.

The Register-Disc-P message transmitted to the HA 1206 by the MN 1210 (transmitting means 1601) is encoded using security association between the HA 1206 and the MN 1210. For example, when the MN 1210 and the HA 1206 support the mobile IP, the Register-Disc-P message can be added to a Binding Update (BU) message as an extension and made secure by IP Security (IPSec).

The MN 1210 may not be able to find the Disc-P in the local domain. In this case, the MN 1210 provides a blank “Local Disc-P List” and indicates its domain information the “Policy Data” field, .e.g. the domain prefix.

When the HA 1206 (receiving means 1500) receives a valid Register-Disc-P message, the controlling means 1503 checks whether the entry for the home address is already present. When the entry is not present, a new entry is created. Otherwise, the old entry is updated using the information from the received message. An example of the entry is shown below.

Disc-P-Record:

=[Home Address]
[Disc-P List: =[[Disc-P]
[Destination Prefix List]]]
[Domain Information]

As described above, the entry is indexed by “Home Address”. The “Disc-P List” includes the Disc-P information of the received “Register-Disc-P message”. The “Disc-P List” includes one or more subentries and sequentially includes the “Disc-P” and a corresponding “Destination Prefix List”. When the “Disc-P” is the default Disc-P of the MN 1210, the “Destination Prefix List” is blank.

The “Domain Information” includes information on the local domain of the MN 1210. The field could be blank when the “Disc-P List” is not blank.

It is clear to a person skilled in the art that, when the HA 1206 supports the mobile IP, the “Disc-P-Record” is added to a binding cache (BC). Therefore, the currently present data structure and management tools can be reused.

As shown in FIG. 13, when the HA 1206 (receiving means 1500) receives the TA-Init-Request message, the HA 1206 uses the judging means 1503 to check whether a “Disc-P-Record” entry related to the “Target Address” of the message is present.

When such an entry is present, and the “Disc-P List” is not blank, the HA 1206 locates a proper Disc-P, such as the Disc-P (1214), based on the associated “Destination Prefix List” and the “Requester Address” of the TA-Init-Request message. The HA 1206 (message generating means 1502) generates a TA-Disc-Init message. The transmitting means 1501 transmits the TA-Disc-Init message towards the Disc-P (1214) (Step S1311). An example of a TA-Disc-Init message format is shown below.

TA-Disc-Init: =[Request Address]
[End Point Address]
[TA Selection Element]
[Policy Data]

The “Requester Address” is copied from the TA-Init-Request message. The “End Point Address” is the address of the Disc-I (1212) if no address is included in the “Policy Data” of the received TA-Init-Request message. The “TA Selection Element” includes the criteria for the TA selection. When a plurality of TA, such as the TA 1216 and the TA 1218, are present on the path, the criteria is used to confirm whether the TA should volunteer itself as a candidate.

The “Policy Data” includes special information used during signaling. For example, the “Policy Data” includes information for Disc-I (1212) to match the discovery signaling with the corresponding request.

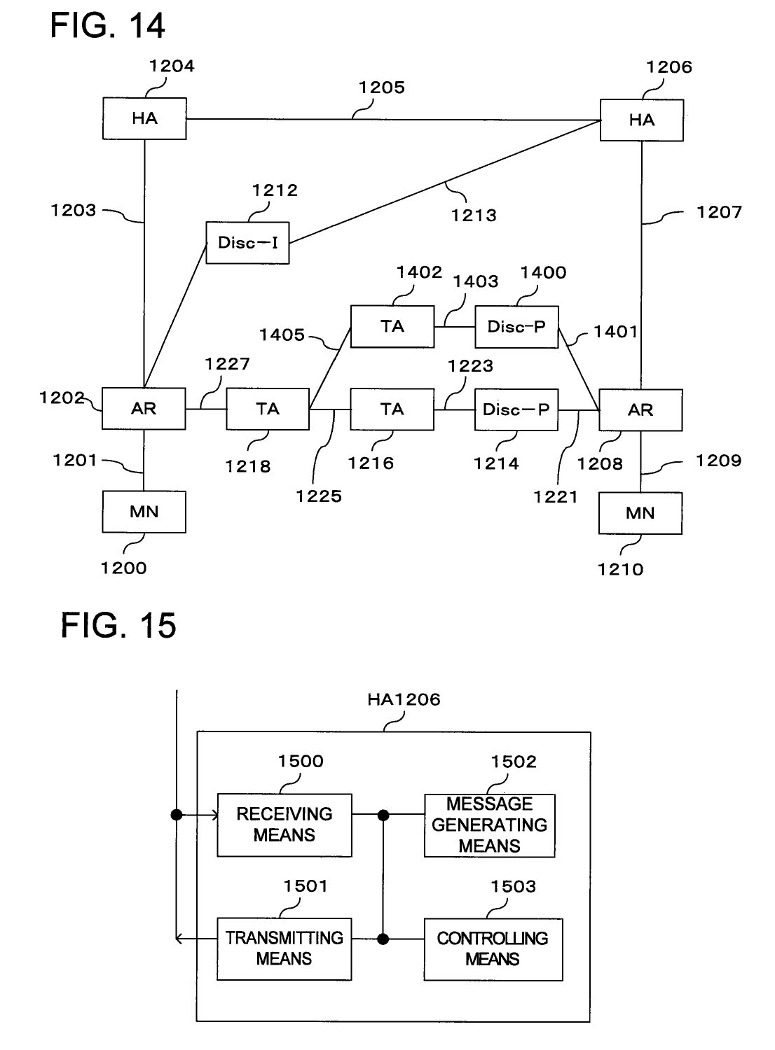

It is clear to a person skilled in the art that the HA 1206 may decides a plurality of Disc-P for a specific address. FIG. 14 shows when the MN 1210 belongs to a multihomed network, such as when the AR 1208 has a plurality of paths leading towards an external network. In such cases, the HA 1206 (transmitting means 1501) transmits a plurality of TA-Disc-Init messages to different Disc-P, such as the Disc-P (1214) and a Disc-P (1400). It is clear to a person skilled in the art that a multihomed MN 1210 brings about a similar situation. The invention can handle such situations under the same principle.

As shown in FIG. 14, when the HA 1206 (controlling means 1503) decides to transmit the TA-Disc-Init message to a plurality of paths, a TA on a shared path, such as the TA 1218, is preferable to other TA, such as a TA 1402 or the TA 1216, because reliability can be ensured. In this case, the HA 1206 includes information related to the “TA Selection Element”. For example, following pieces of information are included.

The pieces of information are a flag indicating that a plurality of paths can be used (such as a pre-defined bit within the header), a counter of overall paths in use (such as an 8-bit path counter), information allowing the Disc-P to generate consistent session ID (such as a 128-bit session ID), and TA selection preference (such as TA candidates should be on the common section of all paths or TA candidates should be on the common section of at least half of the paths).

At Step S1307, when the HA 1206 (controlling means 1503 finds that the “Disc-P List” entry of the “Disc-P-Record” associated with the “Target Address” is blank, the HA 1206 (controlling means 1503) checks the “Domain Information”. For example, in case of a combined binding cache (BC) and the “Disc-P-Record” entry, the “Domain Information” includes the CoA 2 that is the CoA of the MN 1210. The HA 1206 (controlling means 1503) references a backend database to acquire suitable Disc-P information. For example, the HA 1206 can locate a Disc-P controller of the domain specified by the “Domain Information”. The TA-Disc-Init message has related information, such as the “Policy Data” including the CoA 2, and is transmitted towards the Disc-P controller. The Disc-P controller selects a suitable Disc-P based on the “Requester Address” and the “Policy Data” and transmits the TA-Disc-Init message to the corresponding Disc-P. For example, the Disc-P controller can decide the default gateway that can act as the Disc-P for the CoA 2 and transfer the TA-Disc-Init message to the gateway.

As shown in Step S1309, another method by which the HA 1206 locates the suitable Disc-P is the TA-Disc-Init message being transmitted to a unicast-prefix-based multicast address. For example, the TA-Disc-Init message is transmitted towards a multicast address sharing the same prefix as the CoA 2. Therefore, the Disc-P in the domain of the MN 1210 can recognize such multicast addresses and intercept the TA-Disc-Init message. The Disc-P, such as the Disc-P (1214), verify is if it on the path between “Requester Address” the HA 1206 and the CoA stored in the “Policy Data”. It is clear to a person skilled in the art that the Disc-P (1214) has different methods, such as checking the routing table of the AR 1208 or accessing configuration information of the MN 1210 via the DHCP server. The principle of the invention is not affected.

Another method by which the HA 1206 locates the suitable Disc-P is the HA 1206 transmitting a message for Disc-P discovery towards a requester address included in the TA-Disc-Request message, via the AR 1208. In the IP header of the message for Disc-P discovery, a RAO that can be intercepted by a node that can become the Disc-P is added. The first Disc-P-corresponding node that intercepts the message becomes the Disc-P. In the method of transmitting the message for Disc-P discovery towards the requester address via the AR 1208, for example, the message for Disc-P discovery can be encapsulated in the IP packet addressed to the AR 1210 and decapsulated and forwarded at the AR 1210. Alternatively, the message for Disc-P discovery can be forced to pass through the AR 1208 using a method such as Strict Route. However, when encapsulation is not performed, even if the message for Disc-P discovery is intercepted by the Disc-P-capable node on the path between the HA 1206 and the AR 1208, a procedure is required such that the message will not be intercepted until passing through the AR 1208. The Disc-P discovered by this method can return a response to the HA 1206 and notify the HA 1206 that the Disc-P itself is the Disc-P. In addition, the TA-Disc-Init message can also be used as the message for Disc-P discovery. After the Disc-P is discovered, the Disc-P can proceed to the next process or, in other words, Step S1313, without returning the response to the HA 1206.

As shown in FIG. 13, the Disc-P (1214) (receiving means 800) receives the TA-Disc-Init message (Step S1311). The message generating means 802 generates the TA-Disc signaling application message (TA-Disc message). The TA-Disc message is transmitted (by the transmitting means 801) along the data path, from the MN 1210 towards the MN 1200 (Step S1313). To achieve this, a scheme such as the NSIS described in Non-patent Document 3 is used for the TA Discovery.

For example, each TA supports the TA-Disc signaling application. The TA-Disc signaling application is a NSLP layer application. When the TA, such as the TA 1216, receives a NSIS message having a pre-defined NSLP ID for the TA-Discovery signaling application, the TA 1216 performs a process in adherence to the message. The TA 1216 discovers the next TA 1218 and transfers a necessary message to the TA 1218. An example of a TA-Disc message format is shown below.

TA-Disc: =[Session ID]
[Flow ID]
[End Point Address]
[TA Selection Element]
[Policy Data]

Within the message, the “Session ID” is obtained from the “Policy Data” of the received TA-Disc-Init message. The “Flow ID” is generated based on the “Requester Address” and the “address of the Disc-P”. The “End Point Address” is the address of the Disc-I (1212). The “TA Selection Element” is obtained from the received TA-Disc-Init message. The “Policy Data” includes special information for signaling control, such as authorization information.

The TA-Disc message is passed through to the NTLP layer of the Disc-P (1214). The TA-Disc message is transmitted by a NSIS operation procedure to guarantee that the message moves along the data path, from the MN 1210 to the MN 1200. When the TA on the path, such as the TA 1216, receives the TA-Disc message, a verification of whether the TA 1216 supports the TA-Disc signaling application, such as the NSLP ID, is carried out in the NTLP layer. The TA checks the “TA Selection Element” and sees if all criteria can be met. When the TA supports the criteria, the TA adds the address of the TA itself and related information to the TA-Disc message. Otherwise, if possible, the TA 1216 transfers the TA-Disc message to the next peer (Step S1315). An example of the related TA information is shown below.

TA-Info-Element: =[TA Address]
[TA Characteristics]

The “TA Address” is address information of the current TA meeting all criteria. The “TA Characteristics” includes information on, for example, the supported tunneling scheme, encryption, the supported QoS scheme, and the TA usage cost.

The TA 1216 confirms the presence of the next peer (adjacent peer) towards the MN 1200. The confirmation is performed in the NTLP layer using a standard NSIS procedure.

If another TA, such as the TA 1218, is present on the path and the received TA-Disc message does not include the “TA-Info-Element”, the TA 1216 updates the “Flow ID” to a value derived from the address of the TA 1216 itself and the “Requester Address”. The message is passed to the NTLP layer and is transmitted to the next hop peer, such as the TA 1218 (Step S1315).

When at a TA, such as the TA 1218, the NTLP layer cannot locate any further peer on the path, this means that the current TA is the last signaling aware node on the path. In this case, the TA, such as the TA 1218, generates a TA-Response message and transmits the message to the “End Point Address” of the TA-Disc message. In the example, the TA-Response message is transmitted to the Disc-I (1212) (Step S1317). The TA-Response message has the same format as the TA-Disc message.

When the Disc-I (1212) (receiving means 700) receives the TA-Response message, the message generating means 702 collects all “TA-Info-Element” from the message, inserts the collected “TA-Info-Element” into the TA-Disc-Response message, and transmits the TA-Disc-Response message to the MN 1200 (Step S1319). An example of a TA-Disc-Response message is shown below.

TA-Disc-Response: =[TA-Info-Element]
[Policy Data]

One or a plurality of “TA-Info-Element” can be obtained from the received TA-Response message. The “Policy Data” includes information for the MN 1200 to verify the validity of the TA-Disc-Response message and match it with the corresponding TA-Init-Request message. For example, the MN 1200 uses the session information in the “Policy Data” to locate information of the first TA-Init-Request message, such as the “Target Address”.

When one or more “TA-Info-Element” is present within the TA-Disc-Response message, the MN 1200 uses a local policy in determining the suitable TA, such as the TA that is the lowest in cost.

It is clear to a person skilled in the art that, in a scenario such as that shown in FIG. 14, a plurality of TA-Disc messages are transmitted via different paths and arrive at the Disc-I (1212) at different times. In this case, when the Disc-I (1212) (receiving means 700) receives the TA-Response message having the “Policy Data” including a flag indicating a plurality of paths, the transmission of the TA-Response message is halted until the number of arrived TA-Response messages having the same “Session ID” reaches the value of the “Path Counter”.

After all TA-Response messages are received, the Disc-I (1212) (judging means 703) analyzes the “TA-Info-Element” and generates a list including only the TA satisfying the “TA Selection Preference” within the “Policy Data”. For example, the Disc-I (1212) generates a list including only the TA common to all TA-Response messages or only the TA appearing in at least half of the TA-Response messages.

The Disc-I (1212) can stack the “TA-Info-Element” from all received TA-Response messages and transmit the “TA-Info-Element” to the MN 1200. The MN 1200 selects the suitable TA based on the transmitted information. The TA deciding method can be the same as that using the TA-Discovery message transmitted from the pTAE, described according to the first to third embodiments.

### Fifth Embodiment

As shown in FIG. 13, when it is discovered that the HA 1206 (controlling means 1503) cannot use the entry in the “Disc-P Record” at Step S1309, this indicates that the MN 1210 is in the home domain or that the “Target Address” is invalid.

Therefore, the HA 1206 (controlling means 1503) confirms the reachability of the “Target Address”, for example, by pinging the address using an Internet Control Message Protocol (ICMP) message. When the address is reachable, that the MN 1210 is in the home domain is indicated. The HA 1206 acts as the Disc-P (1214). In this case, the HA 1206 (message generating means 1502) generates the TA-Disc message and transmits the generated TA-Disc message towards the “Requester Address” (using the transmitting means 1501).

When the address is not reachable, the HA 1206 (transmitting means 1501) sends an error message stating the reason thereof to the “Requester Address”.

### Sixth Embodiment

When a local mobility scheme, such as a HMIP (refer to Non-patent Document 6), that can be used in the network is present, optimization is possible. For example, the mobility anchor point (MAP) can be selected directly by the MN 1200 as the Disc-P (1212). In this case, the MN 1200 is not required to participate in the TA selection. Instead, the MAP can perform the discovery process for the mobile node. The data path is required to pass through the MAP. Therefore, the TA between the MAP of the mobile node and the CN, or the MAP of the mobile node and the MAP of the CN is used.

As shown in FIG. 13, when the HMIP is used, the MAP acts as the Disc-P (1214) for the MN 1210. In this case, special signaling is not required. The MN 1210 registers a regional CoA (RCOA) that is a local CoA with the HA 1206 using the BU. Therefore, the HA 1206 transmits the TA-Disc-Init message directly to the RCOA. The message is intercepted by the MAP (Disc-P [1214]).

### Seventh Embodiment

At Step S1307, when the HA 1206 (controlling means 1503) finds that the “Requester Address” of the received TA-Init-Request message belongs to the same domain as the Disc-P within the corresponding “Disc-P-Record”, the HA 1206 skips to Step S1311 and the HA 1206 itself acts as the Disc-P. The HA 1206 (transmitting means 1501) transmits the TA-Disc message directly towards the “Requester Address”. In this case, the HA 1206 may include a criteria in the “Policy Data” of TA-Disc requiring the last TA on the path to be selected.

### Eighth Embodiment

It is clear to a person skilled in the art that, for example, both the MN 1200 and the MN 1210 are mobile nodes and may request route optimization. Therefore, the MN 1200 and the MN 1210 would respectively perform the above-described functions. For example, the MN 1200 also registers the local Disc-P with the HA, such as the HA 1204.

When a data transmitting node, such as the MN 1210, attempts to initiate route optimization, the data transmitting node triggers a receiving node, such as the MN 1210, via the upper layer signaling. The receiving node, such as the MN 1200, can perform the processes as described according to the embodiments above.

Each functional block used in the explanations of each embodiment of the present embodiment, described above, can be realized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the integrated circuit (IC), a system LSI, a super LSI, or an ultra LSI. The method of forming the integrated circuit is not limited to LSI and can be actualized by a dedicated circuit or a general-purpose processor. A field programmable gate array (FPGA) that can be programmed after LSI manufacturing or a reconfigurable processor of which connections and settings of the circuit cells within the LSI can be reconfigured can be used. Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

### INDUSTRIAL APPLICABILITY

The node discovery method of the present invention, the proxy node used in the method, the mobile node used in the method, the corresponding node used in the method, and the home agent used in the method can, in the mobile IPv6, detect a TA that can provide a quasi-optimal data path to acquire the quasi-optimal path while protecting location privacy of the MN. Therefore, the node discovery method of the present invention, the proxy node used in the method, the mobile node used in the method, the corresponding node used in the method, and the home agent used in the method are effective in a node discovery method of discovering a node providing a path near an optimal path while protecting location privacy, a proxy node used in the method, a mobile node used in the method, a corresponding node used in the method, a home agent used in the method, and the like.

1. A node discovery method in which, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, a processing node that is a relay node that can process a message in a predetermined format and is positioned on a path over which a data packet transmitted from the mobile node to the corresponding node passes is discovered from among the plurality of relay nodes, the node discovery method comprising a step of:
transmitting, from a first proxy node that is a proxy node that discovers the processing node as a proxy of the mobile node, a first message that is the message in the predetermined format used to discover the processing node to a second proxy node that is a proxy node that discovers the processing node as a proxy of the corresponding node;
judging, by a rely node that has received the first message and can process the message in the predetermined format, whether the relay node itself is the processing node, based on the first message; and
when the relay node judges that the relay node itself is the processing node at the judging step, transmitting, from the relay node that has made the judgment and can process the message in the predetermined format, a second message stating that the relay node itself will become the processing node to the first proxy node.

2. The node discovery method according to claim 1, wherein the first message includes predetermined hop information for making the relay node that can process the message in the predetermined format, positioned a predetermined hop ahead of the first proxy node on a path over which the first message is transmitted, the processing node.

3. A node discovery method in which, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, a processing node that is a relay node that can process a message in a predetermined format and is positioned on a path over which a data packet transmitted from the mobile node to the corresponding node passes is discovered from among the plurality of relay nodes, the node discovery method comprising a step of:
transmitting, from a first proxy node that is a proxy node that discovers the processing node as a proxy of the mobile node, a first message that is the message in the predetermined format used to discover the processing node to a second proxy node that is a proxy node that discovers the processing node as a proxy of the corresponding node;
adding, by a rely node that has received the first message and can process the message in the predetermined format, address information of the relay node itself to the first message and transferring the first message; and
deciding, by the second proxy node, the processing node based on the first message to which the address information has been added.

4. The node discovery method according to claim 3, wherein the second proxy node decides the processing node to be a relay node that can process the message in the predetermined format, positioned halfway between the first proxy node and the second proxy node, based on a number of pieces of address information added to the first message.

5. The node discovery method according to claim 1, wherein the first message includes information prompting the relay node that can process the message in the predetermined format to acquire the first message.

6. The node discovery method according to claim 1, wherein:
the first proxy node is decided by
the mobile node transmitting a third message that is a message in the predetermined format to a predetermined node that can process the message in the predetermined format to extract the first proxy node from among the relay nodes, and
the relay node that can process the message with the predetermined format and has received the third message judging whether the relay node itself is the first proxy node based on the third message and, when judged that the relay node itself is the first proxy node, transmitting a fourth message stating that the relay node itself is the first proxy node to the mobile node.

7. The node discovery method according to claim 6, wherein the third message includes information prompting the relay node that can process the message in the predetermined format to acquire the third message.

8. The node discovery method according to claim 6, wherein the third message includes predetermined hop information for making the relay node that can process the message in the predetermined format, positioned a predetermined hop ahead of the mobile node on a path over which the third message is transmitted, the first proxy node.

9. The node discovery method according to claim 1, wherein the mobile node transmits a fifth message for acquiring address information of the second proxy node to the first proxy node.

10. The node discovery method according to claim 1, wherein:
the mobile node transmits a message requesting designation of the first proxy node to the home agent of the mobile node; and
the home agent of the mobile node decides the first proxy node based on address information of the mobile node and transmits information on the decided first proxy node to the mobile node.

11. The node discovery method according to claim 1, wherein:
when the mobile node moves from the first network and connects to another network within the internetwork,
a first path over which the message in the predetermined format, transmitted to discover a pre-movement processing node that is the processing node when the mobile node is connected to the first network before movement, passes and a second path over which the message in the predetermined format, transmitted to discover the processing node in the other network of a new connection destination, passes intersect and, if a relay node that can process the message in the predetermined format and is immediately after a convergence of the first path and the second path is positioned closer to the mobile node side than the pre-movement processing node on the converged path, the pre-movement processing node is continuously used as the processing node.

12. A proxy node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method, in which a processing node that is a relay node that can process a message in a predetermined format and is positioned on a path over which a data packet transmitted from the mobile node to the corresponding node passes is discovered from among the plurality of relay nodes, and discovers the processing node as a proxy of the mobile node, the proxy node comprising:
a message generating means that generates a first message that is the message in the predetermined format used to discover the processing node;
a transmitting means that transmits the generated first message to a second proxy node that is a proxy node that discovers the processing node as a proxy of the corresponding node; and
a receiving means that, when a rely node that has received the transmitted first message and can process the message in the predetermined format judges that the relay node itself will become the processing node based on the first message, receives a second message from the relay node that has made the judgment stating that the relay node will become the processing node.

13. The proxy node according to claim 12, wherein
the first message includes predetermined hop information for making the relay node that can process the message in the predetermined format, positioned a predetermined hop ahead of the proxy node itself on a path over which the first message is transmitted, the processing node.

14. A proxy node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method, in which a processing node that is a relay node that can process a message in a predetermined format and is positioned on a path over which a data packet transmitted from the mobile node to the corresponding node passes is discovered from among the plurality of relay nodes, and discovers the processing node as a proxy of the mobile node, the proxy node comprising:
a message generating means that generates a first message that is the message in the predetermined format used to discover the processing node;
a transmitting means that transmits the generated first message to a second proxy node that is a proxy node that discovers the processing node as a proxy of the corresponding node; and
a receiving means that that receives a message from the processing node discovered by the second proxy node stating that the processing node itself will become the processing node.

15. The proxy node according to claim 12, wherein the first message includes information prompting the relay node that can process the message in the predetermined format to acquire the first message.

16. The proxy node according to claim 12, further comprising:
a judging means that judges whether the proxy node itself is a first proxy node that is proxy node of the mobile node, based on a third message that is the message in the predetermined format transmitted from the mobile node and received by the receiving means to extract the first proxy node from the relay nodes,
wherein, when the judging means judges that the proxy node itself is the first proxy node, the message generating means generates a fourth message stating that the proxy node itself is the first proxy node, and
the transmitting means transmits the generated fourth message to the mobile node.

17. The proxy node according to claim 16, wherein the third message includes information prompting the relay node that can process the message in the predetermined format to acquire the third message.

18. The proxy node according to claim 16, wherein the third message includes predetermined hop information for making the relay node that can process the message in the predetermined format, positioned a predetermined hop ahead of the mobile node on a path over which the third message is transmitted, the first proxy node.

19. The proxy node according to claim 12, wherein the receiving means receives a fifth message from the mobile node for acquiring address information of the second proxy node.

20. A proxy node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method, in which a processing node that is a relay node that can process a message in a predetermined format and is positioned on a path over which a data packet transmitted from the mobile node to the corresponding node passes is discovered from among the plurality of relay nodes, and discovers the processing node as a proxy of the corresponding node, the proxy node comprising:
a receiving means that receives a first message that is the message in the predetermined format for discovering the processing node transmitted by a first proxy node that is a proxy node that discovers the processing node as a proxy of the mobile node, to which a relay node that has received the first message and can process the message in the predetermined format has added address information of the relay node itself; and
a deciding means that decides the processing node based on the received first message to which the address information has been added.

21. The proxy node according to claim 20, wherein the deciding means decides the processing node to be a relay node that can process the message in the predetermined format, positioned halfway between the first proxy node and the proxy node itself, based on a number of pieces of the address information added to the first message.

22. The proxy node according to claim 20, wherein the first message includes information prompting the relay node that can process the message in the predetermined format to acquire the first message.

23. A mobile node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method, in which a processing node that is a relay node that can process a message in a predetermined format and is positioned on a path over which a data packet transmitted from the mobile node to the corresponding node passes is discovered from among the plurality of relay nodes, the mobile node comprising:
a message generating means that generates a first message that is the message in the predetermined format used to extract a first proxy node that is a proxy node that discovers the processing node, from among the relay nodes, as a proxy of the mobile node;
a transmitting means that transmits the generated first message to a predetermined node that can process the message; and
a receiving means that receives a second message that is sent when a rely node that has received the transmitted first message and can process the message in the predetermined format judges that the relay node itself is the first proxy node and states that the relay node itself is the first proxy node.

24. The mobile node according to claim 23, wherein the first message includes information prompting the relay node that can process the message in the predetermined format to acquire the first message.

25. The mobile node according to claim 23, wherein the first message includes predetermined hop information for making the relay node that can process the message in the predetermined format, positioned a predetermined hop ahead of the mobile node on a path over which the first message is transmitted, the first proxy node.

26. The mobile node according to claim 23, wherein the transmitting means transmits a third message for acquiring address information of a second proxy node that is a proxy node of the corresponding node to the first proxy node.

27. A mobile node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method, in which a processing node that is a relay node that can process a message in a predetermined format and is positioned on a path over which a data packet transmitted from the mobile node to the corresponding node passes is discovered from among the plurality of relay nodes, the mobile node comprising:
a message generating means that generates a message requesting designation of a first proxy node that is a proxy node that discovers the processing node, from among the relay nodes, as a proxy of the mobile node;
a transmitting means that transmits the generated message to the home agent of the mobile node; and
a receiving means that receives information on the first proxy node decided based on address information of the mobile node transmitted by the home agent of the mobile node.

28. A node discovery method in which, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, a processing node that is a relay node positioned on a direct path between the mobile node and the corresponding node is discovered from among the plurality of relay nodes, the node discovery method comprising a step of:
transmitting, from a first proxy node that is a proxy node that discovers the processing node as a proxy of the mobile node, a first message for requesting a discovery of the processing node to the home agent of the corresponding node;
transmitting, from the home agent of the corresponding node, a second message for starting the discovery of the processing node to a second proxy node that is a proxy node that discovers the processing node as a proxy of the corresponding node, based on the first message;
transmitting, from the second proxy node, a third message for discovering the processing node towards the first proxy node, based on the second message; and
when the relay node that has received the third message judges whether the relay node itself can be the processing node based on the third message and judges that the relay node itself can be the processing node, when another relay node that can be the processing node is present between the relay node itself and the first proxy node, adding, by the relay node, address information of the relay node itself to the third message and transferring the message and, when another relay node that can be the processing node is not present between the relay node itself and the first proxy node, transmitting, from the relay node, a fourth message including address information of other relay nodes that can be the processing node included in the third message and address information of the relay node itself to the first proxy node.

29. The node discovery method according to claim 28, wherein the first proxy node transmits the first message to the home agent of the corresponding node when the mobile node requests the discovery of the processing node.

30. The node discovery method according to claim 28, wherein after receiving the fourth message, the first proxy node extracts address information of the relay node that can be the processing node included in the fourth message and transmits a fifth message including the extracted address information to the mobile node.

31. The node discovery method according to claim 28, wherein the home agent of the corresponding node decides the second proxy node based on information for deciding the second proxy node, generated in advance, and information included in the first message and transmits the second message to the decided second proxy node.

32. The node discovery method according to claim 30, wherein:
when the home agent of the corresponding node transmits the second message to a plurality of second proxy nodes,
the first proxy node transmits the fifth message to the mobile node based on information included in the third message transmitted from each the second proxy node, indicating that the message has been transmitted over a plurality of paths.

33. The node discovery method according to claim 28, wherein:
when the corresponding node is present within the second home network,
the home agent of the corresponding node decides to become the second proxy node.

34. The node discovery method according to claim 28, wherein, when a hierarchical mobile internet protocol that is a local mobility scheme is used in the data communication system, a router that is an entrance and an exit of a hierarchical structure is decided as the second proxy node.

35. The node discovery method according to claim 28, wherein, when the first proxy node and the second proxy node belong to a same domain, the home agent of the corresponding node becomes the processing node.

36. A node discovery method in which, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, a processing node that is a relay node positioned on a direct path between the mobile node and the corresponding node is discovered from among the plurality of relay nodes, the node discovery method comprising a step of:
transmitting, from a first proxy node that is a proxy node that discovers the processing node as a proxy of the corresponding node, a first message for requesting a discovery of the processing node to the home agent of the mobile node;
transmitting, from the home agent of the mobile node, a second message for starting the discovery of the processing node to a second proxy node that is a proxy node that discovers the processing node as a proxy of the mobile node, based on the first message;
transmitting, from the second proxy node, a third message for discovering the processing node towards the first proxy node, based on the second message; and
when the relay node that has received the third message judges whether the relay node itself can be the processing node based on the third message and the relay node judges that the relay node itself can be the processing node, when another relay node that can be the processing node is present between the relay node itself and the first proxy node, adding, by the relay node, address information of the relay node itself to the third message and transferring the message and, when another relay node that can be the processing node is not present between the relay node itself and the first proxy node, transmitting, from the relay node, a fourth message including address information of other relay nodes that can be the processing node included in the third message and address information of the relay node itself to the first proxy node.

37. A proxy node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method, in which a processing node that is a relay node positioned on a direct path between the mobile node and the corresponding node is discovered from among the plurality of relay nodes, and discovers the processing node as a proxy of the mobile node, the proxy node comprising:
a message generating means that generates a first message for requesting a discovery of the processing node; and
a transmitting means that transmits the generated first message to the home agent of the corresponding node.

38. The proxy node according to claim 37, further comprising: a receiving means that receives a second message for requesting a discovery of the processing node from the mobile node,
wherein, when the receiving means receives the second message, the first message is transmitted to the home agent of the corresponding node.

39. The proxy node according to claim 38, wherein:
the receiving means receives a third message including address information of the relay node that can be the processing node;
the message generating means extracts the address information of the relay node that can be the processing node included in the third message and generates a fourth message including the extracted address information; and
the transmitting means transmits the generated fourth message to the mobile node.

40. The proxy node according to claim 39, wherein:
when the home agent of the corresponding node transmits a message for starting the discovery of the processing node to a plurality of communication proxy nodes that discovers the processing node as a proxy of the corresponding node,
the transmitting means transmits the fourth message to the mobile node, based on information included in a fifth message for discovering the processing node transmitted from each the communication proxy node, indicating that the message has been transmitted over a plurality of paths.

41. The proxy node according to claim 40, wherein:
when the corresponding node is present within the second home network, the home agent of the corresponding node decides to become the communication proxy node.

42. The proxy node according to claim 40, wherein, when a hierarchical mobile internet protocol that is a local mobility scheme is used in the data communication system, a router that is an entrance and an exit of a hierarchical structure is decided as the communication proxy node.

43. The proxy node according to claim 40, wherein, when the proxy node itself and the communication proxy node belong to a same domain, the home agent of the corresponding node becomes the processing node.

44. A proxy node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method, in which a processing node that is a relay node positioned on a direct path between the mobile node and the corresponding node is discovered from among the plurality of relay nodes, and discovers the processing node as a proxy of the mobile node, the proxy node comprising:
a receiving means that receives a second message for starting a discovery of the processing node based on a first message for requesting the discovery of the processing node;
a message generating means that generates a third message for discovering the processing node based on the received second message; and
a transmitting means that transmits the generated third message to a first proxy node that is proxy node of the corresponding node.

45. A proxy node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method, in which a processing node that is a relay node positioned on a direct path between the mobile node and the corresponding node is discovered from among the plurality of relay nodes, and discovers the processing node as a proxy of the corresponding node, the proxy node comprising:
a receiving means that receives a second message for starting a discovery of the processing node based on a first message for requesting the discovery of the processing node;
a message generating means that generates a third message for discovering the processing node based on the received second message; and
a transmitting means that transmits the generated third message to a first proxy node that is proxy node of the mobile node.

46. The proxy node according to claim 45, wherein:
when the corresponding node is present within the second home network,
the home agent of the corresponding node decides to become the proxy node.

47. The proxy node according to claim 45, wherein, when a hierarchical mobile internet protocol that is a local mobility scheme is used in the data communication system, a router that is an entrance and an exit of a hierarchical structure is decided as the proxy node.

48. The proxy node according to claim 45, wherein, when a mobile node proxy node that discovers the processing node as a proxy of the mobile node and the proxy node belong to a same domain, the home agent of the corresponding node becomes the processing node.

49. A proxy node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method, in which a processing node that is a relay node positioned on a direct path between the mobile node and the corresponding node is discovered from among the plurality of relay nodes, and discovers the processing node as a proxy of the corresponding node, the proxy node comprising:
a message generating means that generates a first message for requesting a discovery of the processing node; and
a transmitting means that transmits the generated first message to the home agent of the mobile node.

50. A mobile node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method, in which a processing node that is a relay node positioned on a direct path between the mobile node and the corresponding node is discovered from among the plurality of relay nodes, the mobile node comprising:
a message generating means that generates a first message for requesting a discovery of the processing node; and
a transmitting means that transmits the generated first message to a first proxy node that discovers the processing node as a proxy of the mobile node.

51. The mobile node according to claim 50 further comprises a receiving means that receives a second message including address information of the relay node that can be the processing node.

52. The mobile node according to claim 50, wherein:
when the corresponding node is present within the second home network,
the home agent of the corresponding node decides to become a second proxy node that discovers the processing node as a proxy of the corresponding node.

53. The mobile node according to claim 50, wherein, when a hierarchical mobile internet protocol that is a local mobility scheme is used in the data communication system, a router that is an entrance and an exit of a hierarchical structure is decided as a second proxy node that discovers the processing node as a proxy of the corresponding node.

54. The mobile node according to claim 50, wherein, when the first proxy node and the second proxy node that discovers the processing node as a proxy of the corresponding node belong to a same domain, the home agent of the corresponding node becomes the processing node.

55. A corresponding node that, in a data communication system in which a mobile node connected to a first network and a corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including a home agent of the corresponding node, is used in a node discovery method, in which a processing node that is a relay node positioned on a direct path between the mobile node and the corresponding node is discovered from among the plurality of relay nodes, the corresponding node comprising:
a message generating means that generates a first message for requesting a discovery of the processing node; and
a transmitting means that transmits the generated first message to a proxy node that discovers the processing node as a proxy of the corresponding node.

56. The corresponding node according to claim 55 further comprises a receiving means that receives a second message including address information of the relay node that can be the processing node.

57. A home agent of a corresponding node that, in a data communication system in which a mobile node connected to a first network and the corresponding node that is a correspondence partner of the mobile node and connected to a second network communicate via a plurality of relay nodes disposed within an internetwork including the first network, the second network, a first home network that is a home network of the mobile node including a home agent of the mobile node and a second home network that is a home network of the corresponding node including the home agent of the corresponding node, is used in a node discovery method, in which a processing node that is a relay node positioned on a direct path between the mobile node and the corresponding node is discovered from among the plurality of relay nodes, the home agent comprising:
a receiving means that receives a first message for requesting a discovery of the processing node from a first proxy node that is a proxy node that discovers the processing node as a proxy of the mobile node;
a message generating means that generates a second message for starting the discovery of the processing node based on the received first message; and
a transmitting means that transmits the generated second message to a second proxy node that discovers the processing node as a proxy of the corresponding node.

58. The home agent according to claim 57, further comprising:
a controlling means that decides the second proxy node based on information for deciding the second proxy, generated in advance, and information included in the first message,
wherein, the transmitting means transmits the second message to the decided second proxy node.

59. The home agent according to claim 58, wherein:
when the controlling means judges that the corresponding node is present within the second home network,
the controlling means decides that the home agent itself will become the second proxy node.

60. The home agent according to claim 57, wherein, when a hierarchical mobile internet protocol that is a local mobility scheme is used in the data communication system, a router that is an entrance and an exit of a hierarchical structure becomes the second proxy node.

61. The home agent according to claim 57, wherein, when the first proxy node and the second proxy node belong to a same domain, the home agent of the corresponding node itself becomes the processing node.

62. A home agent of a mobile node that, in a data communication system in which the mobile node connected to a first network and a corresponding node that is a correspondence partner of the mobile node and connected to a second network communicate via a plurality of relay nodes disposed within an internetwork including the first network, the second network, a first home network that is a home network of the mobile node including the home agent of the mobile node and a second home network that is a home network of the corresponding node including a home agent of the corresponding node, is used in a node discovery method, in which a processing node that is a relay node positioned on a direct path between the mobile node and the corresponding node is discovered from among the plurality of relay nodes, the home agent comprising:
a receiving means that receives a first message for requesting a discovery of the processing node from a first proxy node that is a proxy node that discovers the processing node as a proxy of the corresponding node;
a message generating means that generates a second message for starting the discovery of the processing node based on the received first message; and
a transmitting means that transmits the generated second message to a second proxy node that discovers the
